(19) United States
(12) Patent Application Publication
(10) Pub. No.: US 2025/0188647 A1
(43) Pub. Date: Jun. 12, 2025

(54) COMPOSITIONS COMPRISING INSOLUBLE ALPHA-GLUCAN

(71) Applicant: NUTRITION & BIOSCIENCES USA 4, INC., Rochester, NY (US)

(72) Inventors: Kyle Hyun Chang Kim, Wilmington, DE (US); James Joshua Ohane, Wilmington, DE (US); Yefim Brun, Wilmington, DE (US); Shantanu Kelkar, Wilmington, DE (US); David Valdesueiro, Oegstgeest (NL); Natnael Behabtu, Oegstgeest (NL); Christian Peter Lenges, Wilmington, DE (US)

(21) Appl. No.: 18/847,476

(22) PCT Filed: Mar. 21, 2023
(86) PCT No.: PCT/US2023/015737

§ 371 Date: Sep. 16, 2024

Related U.S. Application Data
(60) Provisional application No. 63/334,893, filed on Apr. 26, 2022.
(60) Provisional application No. 63/321,840, filed on Mar. 21, 2022.
(60) Provisional application No. 63/321,831, filed on Mar. 21, 2022.

(51) Int. Cl. D01D 1/02; D01D 1/06; D01D 5/06

(52) U.S. Cl. CPC D01D 1/02; D01D 1/065; D01D 5/06; D10B 2331/30

(57) ABSTRACT

Disclosed herein are solutions comprising at least a caustic solvent, alpha-glucan or a derivative thereof, and an additive. An additive can include a crosslinking agent, and/or optionally an additive that does not chemically react with the alpha-glucan or derivative thereof. At least about 50% of the glycosidic linkages of the alpha-glucan can be alpha-1,3 glycosidic linkages. Methods are further disclosed for preparing these solutions and using them to produce various solid compositions, which are also disclosed.

This application claims the benefit of U.S. Provisional Appl. Nos. 63/321,831 (filed Mar. 21, 2022), 63/321,840 (filed Mar. 21, 2022) and 63/334,893 (filed Apr. 26, 2022), which are each incorporated herein by reference in their entirety.

### FIELD

The present disclosure is in the field of polysaccharides. For example, the disclosure pertains to compositions comprising insoluble alpha-glucan and at least one crosslinker and/or additive, and use of this material in various applications.

### BACKGROUND

Driven by a desire to use polysaccharides in various applications, researchers have explored for polysaccharides that are biodegradable and that can be made economically from renewably sourced feedstocks. One such polysaccharide is alpha-1,3-glucan, an insoluble glucan polymer characterized by having alpha-1,3-glycosidic linkages. This polymer has been prepared, for example, using a glucosyltransferase enzyme isolated from Streptococcus salivarius (Simpson et al., Microbiology 141:1451-1460, 1995). Also for example, U.S. Pat. No. 7,000,000 disclosed the preparation of a spun fiber from enzymatically produced alpha-1,3-glucan. Various other glucan materials have also been studied for developing new or enhanced applications. For example, U.S. Patent Appl. Publ. No. 2015/0232819 discloses enzymatic synthesis of several insoluble glucans having mixed alpha-1,3 and -1,6 linkages.

New forms of insoluble alpha-glucan are desired to enhance the economic value and performance characteristics of this material in various applications. Addressing this need, described herein are compositions comprising insoluble alpha-glucan and one or more crosslinkers and/or additives.

### SUMMARY

In one embodiment, the present disclosure concerns a solution (e.g., caustic solution/dope solution) comprising at least (a) a caustic solvent, (b) alpha-glucan and/or a derivative thereof, and (c) an additive, wherein the additive is (i) a crosslinking agent, and/or (ii) an additive that does not chemically react with the alpha-glucan or derivative thereof, wherein at least about 50% of the glycosidic linkages of the alpha-glucan are alpha-1,3 glycosidic linkages, and the weight-average degree of polymerization of the alpha-glucan is at least 15, wherein the alpha-glucan or derivative thereof is dissolved in the caustic solvent, and the additive is dissolved or not dissolved in the caustic solvent.

In another embodiment, the present disclosure concerns a method of producing a solution herein. Such a method can comprise: mixing at least an alpha-glucan herein and/or derivative thereof, and an additive herein, with a caustic solvent, wherein the alpha-glucan and/or derivative thereof dissolves in the caustic solvent.

In another embodiment, the present disclosure concerns a method of producing a solid composition. Such a method can comprise: (a) providing a solution herein, (b) putting the solution into a desired form/shape, and (c) removing the caustic solvent from the solution of step (b) to produce a solid composition comprising an alpha-glucan or derivative thereof, and an additive.

In another embodiment, the present disclosure concerns a composition comprising a solid composition produced by a method herein of producing a solid composition, optionally wherein the solid composition is a fiber (e.g., filament), extrusion, fibrid, composite, or film/coating.

In another embodiment, the present disclosure concerns a solid composition that comprises at least water-insoluble alpha-glucan and/or a water-insoluble derivative thereof, wherein (i) the alpha-glucan and/or derivative thereof is crosslinked, and/or (ii) the composition further comprises an additive that is not chemically linked to the alpha-glucan or derivative thereof, wherein at least about 50% of the glycosidic linkages of the alpha-glucan are alpha-1,3 glycosidic linkages, and the weight-average degree of polymerization of the alpha-glucan is at least 15.

In another embodiment, the present disclosure concerns a film composition or coating composition that comprises a water-insoluble alpha-glucan and a hydrophobic additive, wherein (i) at least about 50% of the glycosidic linkages of the alpha-glucan are alpha-1,3 glycosidic linkages, and the weight-average degree of polymerization of the alpha-glucan is at least 15, and (ii) the hydrophobic additive is not chemically linked to the alpha-glucan.

In another embodiment, the present disclosure concerns a method of producing a film composition or coating composition herein. Such a method can comprise: (a) providing a preparation comprising at least (i) a caustic solvent, (ii) water-insoluble alpha-glucan herein, and (iii) hydrophobic additive herein, wherein the alpha-glucan is dissolved in the caustic solvent; (b) contacting the preparation with a substrate; and (c) removing the caustic solvent from the preparation of step (b) to produce a film composition or coating composition comprising the alpha-glucan and the hydrophobic additive.

### BRIEF DESCRIPTION OF THE DRAWINGS

FIG. 1A: Shown are continuous alpha-1,3-glucan dope filaments air-drawn through a meltblown die using an alpha-1,3-glucan dope solution containing crosslinker. Refer to Example 2.

FIG. 1B: Shown is a failed attempt to air-draw alpha-1,3-glucan dope filaments through a meltblown die using an alpha-1,3-glucan dope solution not containing crosslinker. Refer to Example 2.

FIG. 2: Shown are alpha-1,3-glucan films having 5, 10, 15 or 20 wt % (relative to the content of alpha-1,3-glucan in the film) paraffin wax additive. Film is shown on the left side of each image (the right side is not covered by film). Refer to Example 7C.

FIG. 3: Shown are alpha-1,3-glucan films having 10, 15 or 20 wt % (relative to the content of alpha-1,3-glucan in the film) rapeseed oil additive. A drop of water was placed on either the inner side or outer side of the films (inner side of 20 wt % rapeseed oil film not shown). The contact angle of water on the inner side of each film was less than the contact angle of water on the outer side of each film. Refer to Example 7D.

### DETAILED DESCRIPTION

The disclosures of all cited patent and non-patent literature are incorporated herein by reference in their entirety.

Unless otherwise disclosed, the terms “a” and “an” as used herein are intended to encompass one or more (i.e., at least one) of a referenced feature.

Where present, all ranges are inclusive and combinable, except as otherwise noted. For example, when a range of “1 to 5” (i.e., 1-5) is recited, the recited range should be construed as including ranges “1 to 4”, “1 to 3”, “1-2”, “1-2 & 4-5”, “1-3 & 5”, and the like. The numerical values of the various ranges in the present disclosure, unless expressly indicated otherwise, are stated as approximations as though the minimum and maximum values within the stated ranges were both proceeded by the word “about”. In this manner, slight variations above and below the stated ranges can typically be used to achieve substantially the same results as values within the ranges. Also, the disclosure of these ranges is intended as a continuous range including each and every value between the minimum and maximum values.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

It is to be appreciated that certain features of the present disclosure, which are, for clarity, described above and below in the context of aspects/embodiments, may also be provided in combination in a single element. Conversely, various features of the disclosure that are, for brevity, described in the context of a single aspect/embodiment, can also be provided separately or in any sub-combination.

The term “polysaccharide” (or “glycan”) means a polymeric carbohydrate molecule composed of long chains of monosaccharide units bound together by glycosidic linkages and on hydrolysis gives the polysaccharide's constituent monosaccharides and/or oligosaccharides. A polysaccharide herein can be linear or branched, and/or can be a homopolysaccharide (comprised of only one type of constituent monosaccharide) or heteropolysaccharide (comprised of two or more different constituent monosaccharides). Examples of polysaccharides herein include glucan (polyglucose), fructan (polyfructose), galactan (polygalactose), mannan (polymannose), arabinan (polyarabinose), xylan (polyxylose), and soy polysaccharide.

The term “saccharide” and other like terms herein refer to monosaccharides and/or disaccharides/oligosaccharides, unless otherwise noted. A “disaccharide” herein refers to a carbohydrate having two monosaccharides joined by a glycosidic linkage. An “oligosaccharide” herein can refer to a carbohydrate having 3 to 15 monosaccharides, for example, joined by glycosidic linkages. An oligosaccharide can also be referred to as an “oligomer”. Monosaccharides (e.g., glucose and/or fructose) comprised within disaccharides/oligosaccharides can be referred to as “monomeric units”, “monosaccharide units”, or other like terms.

A “glucan” herein is a type of polysaccharide that is a polymer of glucose (polyglucose). A glucan can be comprised of, for example, about, or at least about, 90%, 91%, 92%, 93%, 94%, 95%, 96%, 97%, 98%, 99%, or 100% by weight glucose monomeric units. Examples of glucans herein include alpha-glucans.

The terms “alpha-glucan”, “alpha-glucan polymer” and the like are used interchangeably herein. An alpha-glucan is a polymer comprising glucose monomeric units linked together by alpha-glycosidic linkages. In typical aspects, the glycosidic linkages of an alpha-glucan herein are about, or at least about, 80%, 81%, 82%, 83%, 84%, 85%, 86%, 87%, 88%, 89%, 90%, 91%, 92%, 93%, 94%, 95%, 96%, 97%, 98%, 99%, or 100% alpha-glycosidic linkages. Examples of an alpha-glucan polymer herein include alpha-1,3-glucan.

The terms “alpha-1,3-glucan”, “poly alpha-1,3-glucan”, “alpha-1,3-glucan polymer” and the like are used interchangeably herein. Alpha-1,3-glucan is an alpha-glucan comprising glucose monomeric units linked together by glycosidic linkages, wherein at least about 50% of the glycosidic linkages are alpha-1,3. Alpha-1,3-glucan in some aspects comprises about, or at least about, 90%, 95%, or 100% alpha-1,3 glycosidic linkages. Most or all of the other linkages, if present, in alpha-1,3-glucan herein typically are alpha-1,6, though some linkages may also be alpha-1,2 and/or alpha-1,4. Alpha-1,3-glucan herein is typically water-insoluble.

The terms “dextran”, “dextran polymer”, “dextran molecule”, “alpha-1,6-glucan” and the like in some aspects herein refer to a water-soluble alpha-glucan comprising at least 50%, 60%, 70%, 80%, 85%, 90%, 95%, 96%, 97%, 98%, 99%, or 99.5% alpha-1,6 glycosidic linkages (with the balance of the linkages typically being all or mostly alpha-1,3).

The term “copolymer” herein refers to a polymer comprising at least two different types of alpha-glucan, such as dextran and alpha-1,3-glucan. The terms “graft copolymer”, “branched copolymer” and the like herein generally refer to a copolymer comprising a “backbone” (or “main chain”) and one or more side chains branching from the backbone. The side chain(s) is/are structurally distinct from the backbone. Examples of graft copolymers herein comprise a dextran backbone (or dextran backbone that has been modified with about 1%-35% alpha-1,2 and/or alpha-1,3 branches, e.g.), and at least one side chain of alpha-1,3-glucan comprising at least about 50% alpha-1,3 glycosidic linkages. An alpha-1,3-glucan side chain herein can have a linkage and molecular weight of alpha-1,3-glucan as disclosed herein, for example. In some aspects, a dextran backbone can have an alpha-1,3-glucan extension, since the non-reducing end(s) of dextran can prime alpha-1,3-glucan synthesis by a glucosyltransferase enzyme.

The terms “linkage”, “glycosidic linkage”, “glycosidic bond” and the like refer to the covalent bonds connecting the sugar monomers within a saccharide compound (oligosaccharides and/or polysaccharides). Examples of glycosidic linkages include 1,6-alpha-D-glycosidic linkages (herein also referred to as “alpha-1,6” linkages) and 1,3-alpha-D-glycosidic linkages (herein also referred to as “alpha-1,3” linkages).

The glycosidic linkage profile of a polysaccharide or derivative thereof can be determined using any method known in the art. For example, a linkage profile can be determined using methods using nuclear magnetic resonance (NMR) spectroscopy (e.g., ¹³C NMR and/or ¹H NMR). These and other methods that can be used are disclosed in, for example, Food Carbohydrates: Chemistry, Physical Properties, and Applications (S. W. Cui, Ed., Chapter 3, S. W. Cui, Structural Analysis of Polysaccharides, Taylor & Francis Group LLC, Boca Raton, FL, 2005), which is incorporated herein by reference.

An “alpha-1,2 branch” (and like terms) as referred to herein typically comprises a glucose that is alpha-1,2-linked to a dextran backbone; thus, an alpha-1,2 branch herein can also be referred to as an alpha-1,2,6 linkage. An alpha-1,2 branch herein typically has one glucose group (can optionally be referred to as a pendant glucose).

An “alpha-1,3 branch” (and like terms) as referred to herein typically comprises a glucose that is alpha-1,3-linked to a dextran backbone; thus, an alpha-1,3 branch herein can also be referred to as an alpha-1,3,6 linkage. An alpha-1,3 branch herein typically has one glucose group (can optionally be referred to as a pendant glucose).

The percent branching in a polysaccharide herein refers to that percentage of all the linkages in the polysaccharide that represent branch points. For example, the percent of alpha-1,3 branching in an alpha-glucan herein refers to that percentage of all the linkages in the glucan that represent alpha-1,3 branch points. Except as otherwise noted, linkage percentages disclosed herein are based on the total linkages of a polysaccharide, or the portion of a polysaccharide for which a disclosure specifically regards.

The “molecular weight” of a polysaccharide or polysaccharide derivative herein can be represented as weight-average molecular weight (Mw) or number-average molecular weight (Mn), the units of which are in Daltons (Da) or grams/mole. Alternatively, molecular weight can be represented as DPw (weight average degree of polymerization) or DPn (number average degree of polymerization). The molecular weight of smaller polysaccharide polymers such as oligosaccharides can optionally be provided as “DP” (degree of polymerization), which simply refers to the number of monomers comprised within the polysaccharide; “DP” can also characterize the molecular weight of a polymer on an individual molecule basis. Various means are known in the art for calculating these various molecular weight measurements such as with high-pressure liquid chromatography (HPLC), size exclusion chromatography (SEC), or gel permeation chromatography (GPC).

As used herein, Mw can be calculated as Mw=ΣNiMi²/ΣNiMi; where Mi is the molecular weight of an individual chain i and Ni is the number of chains of that molecular weight. Besides SEC, the Mw of a polymer can be determined by other techniques such as static light scattering, mass spectrometry, MALDI-TOF (matrix-assisted laser desorption/ionization time-of-flight), small angle X-ray or neutron scattering, or ultracentrifugation. As used herein, Mn can be calculated as Mn=ΣNiMi/ΣNi where Mi is the molecular weight of a chain i and Ni is the number of chains of that molecular weight. Besides SEC, the Mn of a polymer can be determined by various colligative property methods such as vapor pressure osmometry, end-group determination by spectroscopic methods such as proton NMR, proton FTIR, or UV-Vis. As used herein, DPn and DPw can be calculated from Mw and Mn, respectively, by dividing them by molar mass of the one monomer unit M₁. In the case of unsubstituted glucan polymer, M₁=162. In the case of a substituted (derivatized) glucan polymer, M₁=162+M_{f}×DoS, where M_{f} is molar mass of the substituting group, and DoS is degree of substitution (average number of substituted groups per one glucose unit of the glucan polymer).

A “cake” of insoluble alpha-glucan herein refers to a preparation in condensed, compacted, packed, squeezed, and/or compressed form that comprises at least (i) about 50%-90% by weight water or an aqueous solution, and (ii) about 10%-50% by weight insoluble alpha-glucan. In some aspects, a cake of insoluble alpha-glucan herein can comprise at least (i) about 20%-90% by weight water or an aqueous solution, and (ii) about 10%-80% by weight insoluble alpha-glucan. A cake in some aspects can be referred to as a “filter cake” or a “wet cake”. A cake herein typically has a soft, solid-like consistency.

A composition herein that is “dry” or “dried” typically has less than about 12, 11, 10, 9, 8, 7, 6, 5, 4, 3, 2, 1, 0.5, or 0.1 wt % water comprised therein.

The terms “aqueous liquid”, “aqueous fluid”, “aqueous conditions”, “aqueous reaction conditions”, “aqueous setting”, “aqueous system” and the like as used herein can refer to water or an aqueous solution. An “aqueous solution” herein can comprise one or more dissolved salts, where the maximal total salt concentration can be about 3.5 wt % in some aspects. Although aqueous liquids herein typically comprise water as the only solvent in the liquid, an aqueous liquid can optionally comprise one or more other solvents (e.g., polar organic solvent) that are miscible in water. Thus, an aqueous solution can comprise a solvent having at least about 10 wt % water.

An “aqueous composition” herein has a liquid component that comprises about, or at least about, 10, 20, 30, 40, 50, 60, 70, 80, 90, 95, 99, or 100 wt % water, for example. Examples of aqueous compositions include some mixtures, solutions, dispersions (e.g., colloidal dispersions), suspensions and emulsions, for example.

As used herein, the term “colloidal dispersion” refers to a heterogeneous system having a dispersed phase and a dispersion medium, i.e., microscopically dispersed insoluble particles are suspended throughout another substance (e.g., an aqueous composition such as water or aqueous solution). An example of a colloidal dispersion herein is a hydrocolloid. All, or a portion of, the particles of a colloidal dispersion such as a hydrocolloid can comprise insoluble alpha-glucan as presently disclosed. The terms “dispersant” and “dispersion agent” are used interchangeably herein to refer to a material that promotes the formation and/or stabilization of a dispersion. “Dispersing” herein refers to the act of preparing a dispersion of a material in an aqueous liquid.

An alpha-glucan or derivative thereof that is “insoluble”, “aqueous-insoluble”, “water-insoluble” (and like terms) (e.g., alpha-1,3-glucan with a DP of 8 or higher) herein does not dissolve (or does not appreciably dissolve) in water or other aqueous conditions, optionally where the aqueous conditions are further characterized to have a pH of 4-9 or 4-9.9 (e.g., pH 6-8) (i.e., non-caustic aqueous conditions) and/or temperature of about 1 to 130° C. (e.g., 20-25° C.). In some aspects, less than 1.0 gram (e.g., no detectable amount) of an aqueous-insoluble alpha-glucan herein dissolves in 1000 milliliters of such aqueous conditions (e.g., water at 23° C.). In contrast, glucans such as certain oligosaccharides herein that are “soluble”, “aqueous-soluble”, “water-soluble” and the like (e.g., alpha-1,3-glucan with a DP less than 8) appreciably dissolve under these conditions. An aqueous-insoluble alpha-glucan herein or derivative thereof is typically soluble in caustic aqueous conditions (e.g., aqueous solution of pH≥11, 10.5, or 10.0, optionally with a temperature of about 1 to 130° C. [e.g., 20-25° C.]).

The term “viscosity” as used herein refers to the measure of the extent to which a fluid (aqueous or non-aqueous) resists a force tending to cause it to flow. Various units of viscosity that can be used herein include centipoise (cP, cps) and Pascal-second (Pa·s), for example. A centipoise is one one-hundredth of a poise; one poise is equal to 0.100 kg·m⁻¹·s⁻¹. Viscosity can be reported as “intrinsic viscosity” (IV, η, units of dL/g) in some aspects; this term refers to a measure of the contribution of a glucan polymer to the viscosity of a liquid (e.g., solution) comprising the glucan polymer. IV measurements herein can be obtained, for example, using any suitable method such as disclosed in U.S. Pat. Appl. Publ. Nos. 2017/0002335, 2017/0002336, or 2018/0340199, or Weaver et al. (J. Appl. Polym. Sci. 35:1631-1637) or Chun and Park (Macromol. Chem. Phys. 195:701-711), which are all incorporated herein by reference. IV can be measured, in part, by dissolving glucan polymer (optionally dissolved at about 100° C. for at least 2, 4, or 8 hours) in DMSO with about 0.9 to 2.5 wt % (e.g., 1, 2, 1-2 wt %) LiCl, for example. IV herein can optionally be used as a relative measure of molecular weight.

The terms “contact angle”, “wetting angle” and like terms herein refer to the angle that is formed when a droplet of water or aqueous solution is placed on a material surface and the drop forms a dome shape on the surface. The angle formed between the material surface and the line tangent to the edge of the drop is the contact angle. For instance, as a drop of water spreads across a material surface and the drop's dome becomes flatter, the contact angle becomes smaller. If the drop of water beads up on the material surface (e.g., when there is high surface tension), the drop's dome is taller and the contact angle becomes larger.

The term “zeta potential” as used herein refers to the electrical potential difference between a dispersion medium and the stationary layer of fluid attached to a particle dispersed in the dispersion medium. In general, a dispersed particle with a high zeta potential (negative or positive) is more electrically stabilized compared to a dispersed material with low zeta potentials (closer to zero). Since the repulsive forces of a high zeta potential material in a dispersion tend to exceed its attractive forces, such a dispersion is relatively more stable than a dispersion of low zeta potential material, which tends to more easily flocculate/coagulate. Zeta potential herein can be measured as disclosed, for example, in U.S. Patent. Nos. 6109098 or 4602989, U.S. Patent Appl. Publ. No. 2020/0131281, or Int. Patent Appl. Publ. Nos. WO2014/097402 or EP0869357, which are incorporated herein by reference.

The terms “crosslink”, “crosslinked” and the like herein refer to one or more bonds (typically covalent) that connect polymers such as insoluble alpha-glucan or derivative thereof as presently disclosed. A crosslink having multiple bonds typically comprises one or more atoms that are part of a crosslinking agent that was used to form the crosslink. The terms “crosslinking agent”, “crosslinker” and the like herein refer to an atom or compound that can create crosslinks. The term “crosslinking reaction” and like terms (e.g., “crosslinking composition”, “crosslinking preparation”) herein typically refer to a reaction comprising at least a solvent, a crosslinking agent, and aqueous-insoluble alpha-glucan or derivative thereof, and optionally a non-crosslinker additive; a crosslinking reaction herein can be held under caustic conditions herein or non-caustic conditions herein.

A “dope solution”, “dope”, “caustic solution”, “basic solution”, “alkaline solution” and the like herein refer to a solution (typically aqueous with pH≥11) in which one or more of an water-insoluble alpha-glucan, water-insoluble derivative thereof, and/or water-insoluble crosslinked alpha-glucan (e.g., all being insoluble in aqueous solution of pH 4-9) is/are dissolved. An additive herein may or may not be soluble in a caustic solution herein.

A “dope filament” (and like terms) herein refers to a filament of dope solution. Typically, a dope filament is formed by transiting a dope solution herein through a hole or nozzle, such as from a spinneret, die, or other device useful for forming a dope filament. A dope filament can be exposed to acid to coagulate its dissolved component(s) into a fiber filament, for example. As another example, a dope filament can be air-blown to remove liquid thereby forming a fiber filament of its previously dissolved component(s).

A “polysaccharide derivative” (and like terms) herein (e.g., a glucan derivative such as an alpha- or beta-glucan derivative) typically refers to a polysaccharide that has been substituted with at least one type of organic group. The degree of substitution (DoS) of a polysaccharide derivative herein can be up to about 3.0 (e.g., about 0.001 to about 3.0). An organic group can be linked to a polysaccharide derivative herein via an ether, ester, carbamate/carbamoyl, or sulfonyl linkage, for example. A precursor of a polysaccharide derivative herein refers to the non-derivatized polysaccharide used to make the derivative (can also be referred to as the polysaccharide portion of the derivative). An organic group herein can be uncharged (neutral) or charged (anionic or cationic), for example; generally, such charge can be as it exists when the organic group is in an aqueous composition herein, further taking into account the pH of the aqueous composition (in some aspects, the pH can be 4-10 or 5-9, or any pH as disclosed herein).

The term “degree of substitution” (DoS, or DS) as used herein refers to the average number of hydroxyl groups that are substituted with organic groups (e.g., via an ether, ester, or other linkage herein) in each monomeric unit of a polysaccharide derivative. The DoS of a polysaccharide derivative herein can be stated with reference to the DoS of a specific substituent, or the overall DoS, which is the sum of the DoS values of different substituent types (e.g., if a mixed ether or mixed ester). Unless otherwise disclosed, when DoS is not stated with reference to a specific substituent type, the overall DoS is meant. DoS in some aspects herein (such as for a hybrid solid composition) can optionally be characterized as “effective DoS”, wherein the DoS measurement is taken for a polysaccharide sample having two or more populations of the same polysaccharide (e.g., of same molecular weight and linkage profile), but where each polysaccharide population has a different DoS with the same organic group. For example, an effective DoS could be measured for a hybrid solid composition herein having some amount of ether-derivatized alpha-glucan (e.g., having a DoS of 0.001 to 3.0 one particular organic group) and some amount of non-derivatized alpha-glucan (DoS 0.0). Any DoS value/range disclosed herein can be an effective DoS in some aspects.

Terms used herein regarding “ethers” (e.g., polysaccharide ether derivative) can be as disclosed, for example, in U.S. Patent Appl. Publ. Nos. 2014/179913, 2016/0304629, 2016/0311935, 2015/0239995, 2018/0230241, 2018/0237816, or 2020/0002646, or Int. Patent Appl. Publ. Nos. WO2021/252569, WO2021/247810, or WO2021257786, or U.S. Patent Appl. No. 63/276,163, which are each incorporated herein by reference. The terms “polysaccharide ether derivative”, “polysaccharide ether compound”, “polysaccharide ether”, and the like are used interchangeably herein. A polysaccharide ether derivative herein is polysaccharide that has been etherified with one or more organic groups such that the derivative has a DoS with one or more organic groups of up to about 3.0 (e.g., about 0.001 to about 3.0). A polysaccharide ether derivative is termed an “ether” herein by virtue of comprising the substructure —C_{G}—O—C—, where “—C_{G}—” represents a carbon atom of a monomeric unit (e.g., glucose) of the polysaccharide ether derivative (where such carbon atom was bonded to a hydroxyl group [—OH] in the polysaccharide precursor of the ether), and where “—C—” is a carbon atom of an organic group. Examples of polysaccharide ethers herein include glucan ethers (e.g., alpha- or beta-glucan ether).

An organic group in some aspects can refer to a chain of one or more carbons that (i) has the formula —CₙH₂ₙ₊₁ (i.e., an alkyl group, which is completely saturated) or (ii) is mostly saturated but has one or more hydrogens substituted with another atom or functional group (i.e., a “substituted alkyl group”). Such substitution may be with one or more hydroxyl groups, oxygen atoms (thereby forming an aldehyde or ketone group), carboxyl groups, or other alkyl groups. Thus, as examples, an organic group herein can be an alkyl group, carboxy alkyl group, or hydroxy alkyl group.

A “carboxy alkyl” group herein refers to a substituted alkyl group in which one or more hydrogen atoms of the alkyl group are substituted with a carboxyl group. A “hydroxy alkyl” group herein refers to a substituted alkyl group in which one or more hydrogen atoms of the alkyl group are substituted with a hydroxyl group. A carboxy alkyl group (e.g., carboxymethyl) is typically anionic in aqueous conditions.

An organic group can refer to a “positively charged organic group”. A positively charged organic group as used herein refers to a chain of one or more carbons (“carbon chain”) that has one or more hydrogens substituted with another atom or functional group (i.e., a “substituted alkyl group”), where one or more of the substitutions is with a positively charged group. Where a positively charged organic group has a substitution in addition to a substitution with a positively charged group, such additional substitution may be with one or more hydroxyl groups, oxygen atoms (thereby forming an aldehyde or ketone group), alkyl groups, and/or additional positively charged groups. A positively charged organic group has a net positive charge since it comprises one or more positively charged groups. The terms “positively charged group”, “positively charged ionic group”, “cationic group” and the like are used interchangeably herein. A positively charged group comprises a cation (a positively charged ion). Examples of positively charged groups include substituted ammonium groups, carbocation groups and acyl cation groups.

The terms “substituted ammonium group”, “substituted ammonium ion” and “substituted ammonium cation” are used interchangeably herein. A substituted ammonium group herein comprises Structure I:

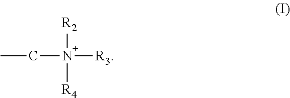

R₂, R₃ and R₄ in Structure I each independently represent a hydrogen atom or an alkyl, aryl, cycloalkyl, aralkyl, or alkaryl group. The positioning of R₂, R₃ and R₄ in Structure I is generally of no particular importance and not intended to invoke any particular stereochemistry. The carbon atom (C) in Structure I is part of the chain of one or more carbons (“carbon chain”) of the positively charged organic group. The carbon atom is either directly ether-linked to a monomeric unit (e.g., glucose) of a polysaccharide herein (e.g., alpha-glucan), or is part of a chain of two or more carbon atoms ether-linked to the monomeric unit. The carbon atom in Structure I can be —CH₂—, —CH— (where an H is substituted with another group such as a hydroxy group), or —C— (where both H's are substituted).

A substituted ammonium group can be a “primary ammonium group”, “secondary ammonium group”, “tertiary ammonium group”, or “quaternary ammonium” group, depending on the composition of R₂, R₃ and R₄ in Structure I. A primary ammonium group herein refers to Structure I in which each of R₂, R₃ and R₄ is a hydrogen atom (i.e., —C—NH₃⁺). A secondary ammonium group herein refers to Structure I in which each of R₂ and R₃ is a hydrogen atom and R₄ is an alkyl, aryl, cycloalkyl, aralkyl, or alkaryl group. A tertiary ammonium group herein refers to Structure I in which R₂ is a hydrogen atom and each of R₃ and R₄ is independently an alkyl, aryl, cycloalkyl, aralkyl, or alkaryl group. A quaternary ammonium group herein refers to Structure I in which each of R₂, R₃ and R₄ is independently an alkyl, aryl, cycloalkyl, aralkyl, or alkaryl group (i.e., none of R₂, R₃ and R₄ is a hydrogen atom). It would be understood that a fourth member (i.e., R₁) implied by the above nomenclature is the one or more carbons (e.g., chain) of the positively charged organic group that is ether-linked to a monomeric unit (e.g., glucose) of a polysaccharide herein (e.g., alpha-glucan).

A quaternary ammonium polysaccharide ether (e.g., alpha-glucan ether) herein can comprise a trialkyl ammonium group (where each of R₂, R₃ and R₄ is an alkyl group), for example. A trimethylammonium group is an example of a trialkyl ammonium group, where each of R₂, R₃ and R₄ is a methyl group. It would be understood that a fourth member (i.e., R₁) implied by “quaternary” in this nomenclature is the chain of one or more carbons of the positively charged organic group that is ether-linked to a monomeric unit of the polysaccharide.

An example of a quaternary ammonium polysaccharide ether is trimethylammonium hydroxypropyl polysaccharide. The positively charged organic group of this ether compound can be represented as Structure II:

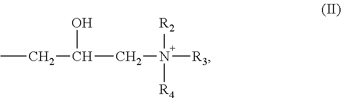

where each of R₂, R₃ and R₄ is a methyl group. Structure II is an example of a quaternary ammonium hydroxypropyl group.

Terms used herein regarding “esters” (e.g., polysaccharide ester derivative) can be as disclosed, for example, in U.S. Patent Appl. Publ. Nos. 2014/0187767, 2018/0155455, or 2020/0308371, or Int. Patent Appl. Publ. No. WO2021/252575, each of which are incorporated herein by reference. The terms “polysaccharide ester derivative”, “polysaccharide ester compound”, “polysaccharide ester”, and the like are used interchangeably herein. A polysaccharide ester derivative herein is polysaccharide that has been esterified with one or more organic groups (i.e., acyl groups) (e.g., charged organic group such as anionic or cationic) such that the derivative has a DoS with one or more organic groups of up to about 3.0 (e.g., about 0.001 to about 3.0). A polysaccharide ester derivative is termed an “ester” herein by virtue of comprising the substructure —C_{G}—O—CO—C—, where “—C_{G}—” represents a carbon atom of a monomeric unit (e.g., glucose) of the polysaccharide ester derivative (where such carbon atom was bonded to a hydroxyl group [—OH] in the polysaccharide precursor of the ester), and where “—CO—C—” is comprised in the acyl group. Examples of polysaccharide esters herein include glucan esters (e.g., alpha- or beta-glucan ester).

The terms “polysaccharide carbamate derivative”, “polysaccharide carbamate”, “carbamoyl polysaccharide” and the like are used interchangeably herein. A polysaccharide carbamate derivative contains the linkage moiety —OCONH— or

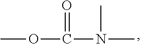

and thus comprises the substructure —C_{G}—OCONH—CR—or —CG-OCON—C_{R2}—, where “—CG-” represents a carbon of a monomer unit (e.g., glucose) of the polysaccharide carbamate derivative, and “—C_{R}—” is comprised in the organic group. In some aspects, the nitrogen atom of a carbamate/carbamoyl moiety is linked to a hydrogen atom and an organic group. In some aspects, however, the nitrogen atom of a carbamate/carbamoyl moiety is linked to two organic groups (as indicated by “—C_{R2}—” above), which can be the same (e.g., two methyl groups, two ethyl groups) or different (e.g., a methyl group and an ethyl group). Examples of polysaccharide carbamates herein include glucan carbamates (e.g., alpha- or beta-glucan carbamate). Carbamate groups herein can be as disclosed in Int. Patent Appl. Publ. No. WO2021/252569, for example, which is incorporated herein by reference.

The terms “polysaccharide sulfonyl derivative”, “sulfonyl polysaccharide” and the like are used interchangeably herein. A polysaccharide sulfonyl derivative contains the linkage moiety —OSO₂—, and thus comprises the substructure —C_{G}—O—SO₂—C_{R}—, where “—C_{G}—” represents a carbon of a monomer unit (e.g., glucose) of the polysaccharide sulfonyl derivative, and “—C_{R}—” is comprised in the organic group. A sulfonyl linkage herein is not ionizable. Sulfonyl groups of a polysaccharide sulfonyl derivative herein can be as disclosed in Int. Patent Appl. Publ. No. WO2021/252569, for example, which is incorporated herein by reference.

A “sulfonate” group herein can be as disclosed, for example, in Int. Pat. Appl. Publ. No. WO2019/246228 or U.S. Patent Appl. Publ. No. 2021/0253977, which are incorporated herein by reference.

An additive that “does not chemically react” (and like terminology) with an alpha-glucan or alpha-glucan derivative does not alter the chemical structure of the alpha-glucan or alpha-glucan derivative. The presence of an additive in some aspects does not lead to substitution of one or more hydrogens (of glucose monomer hydroxyl groups) with a group (e.g., an ether or ester group, such as any disclosed herein) originating from the additive. The presence of an additive in some aspects does not lead to hydrolysis (or other breakage) of one or more (i) glycosidic linkages and/or (ii) intra-glucose monomer carbon-carbon bonds; however, in some aspects, an additive can lead to one of both of these degradatory effects. In some aspects, however, an additive does chemically react with an alpha-glucan or alpha-glucan derivative.

The term “hydrophobic” herein refers to a molecule/compound (e.g., additive herein) or substituent that is nonpolar and has little or no affinity to water, and tends to repel water. The term “hydrophilic” herein refers to a molecule/compound (e.g., additive herein) or a substituent that is polar and has affinity to interact with polar solvents (e.g., water) and/or with other polar groups. A hydrophilic molecule or substituent tends to attract water.

The terms “fiber”, “fibers” and the like herein can refer to staple fibers (staple length fibers) or continuous fibers (filaments), for example. Fibers of the disclosure can comprise alpha-1,3-glucan and an additive, for example. Fibers can be comprised in a fiber-containing composition, article, material, or product, for example, such as a woven product or non-woven product.

The term “woven product” and like terms herein refer to a product formed by weaving, braiding, interlacing, or otherwise intertwining threads or fibers in an organized, consistent, and/or repeating manner.

The terms “non-woven”, “non-woven product”, “non-woven web” and the like herein refer to a web of individual fibers (e.g., filaments or staple fibers) that are interlaid, typically in a random or unidentifiable manner. This contrasts with a knitted or woven fabric, which has an identifiable network of fibers. In some aspects, a non-woven product comprises a non-woven web that is bound or attached to another material such as a substrate or backing. A non-woven in some aspects can further contain a binder or adhesive (strengthening agent) that binds adjacent non-woven fibers together. A non-woven binder or adhesive agent can be applied to the non-woven in the form of a dispersion/latex, solution, or solid, for example, and then the treated non-woven is typically dried.

The terms “fabric”, “textile”, “cloth” and the like are used interchangeably herein to refer to a woven material having a network of fibers. Such fibers can be in the form of thread or yarn, for example. However, in some aspects, a fabric can comprise non-woven fibers.

The term “fibrids”, “fibrillated glucan” and the like as used herein can refer to nongranular, fibrous, or film-like particles with at least one of their three dimensions being of minor magnitude relative to the largest dimension. Fibrids of the disclosure can comprise alpha-1,3-glucan and an additive, for example. In some aspects, a fibrid can have a fiber-like and/or a sheet-like structure with a relatively large surface area when compared to a fiber. The surface area of fibrids herein can be, for example, about 5 to 50 meter²/gram of material, with the largest dimension of about 10 to 1000 microns and the smallest dimension of 0.05 to 0.25 microns (aspect ratio of largest to smallest dimension of 40 to 20000). Fibrids in some aspects can be defined as material produced when a caustic solution herein comprising an aqueous-insoluble alpha-glucan (or aqueous-insoluble alpha-glucan derivative) and an additive is subjected to shearing forces while also being subjected to conditions that precipitate the glucan and additive contents of the caustic solution.

The terms “film”, “sheet” and like terms herein refer to a generally thin, visually continuous material. A film can be comprised as a layer or coating on a material, or can be alone (e.g., not attached to a material surface; free- or self-standing). A “coating” (and like terms) as used herein refers to a layer covering a surface of a material. A film, sheet, or coating of the disclosure can comprise alpha-1,3-glucan and an additive, for example. The term “uniform thickness” as used to characterize a film or coating herein can refer to a contiguous area that (i) is at least 20% of the total film/coating area, and (ii) has a standard deviation of thickness of less than about 50 nm, for example. The term “continuous layer” means, for example, a layer of a composition applied to at least a portion of a substrate, wherein a dried layer of the composition covers ≥99% of the surface to which it has been applied and having less than 1% voids in the layer that expose the substrate surface. The >99% of the surface to which the layer has been applied excludes any area of the substrate to which the layer has not been applied. A coating herein can make a continuous layer in some aspects.

A “composite” herein is a composition that comprises two or more components of the present disclosure (e.g., alpha-1,3-glucan and an additive). Typically, the components of a composite resist separation and one or more of the components display enhanced and/or different properties as compared to its properties alone, outside the composite (i.e., a composite is not simply an admixture, which generally is easily separable to its original components). A composite herein generally is a solid material (typically dry), and can be made via an extrusion or molding process, for example.

A “wax” herein typically refers to an ester of a single fatty acid with a single long-chain alcohol. Generally, a wax is solid at temperatures below 45 or 50° C., and/or is aqueous insoluble under both caustic and non-caustic conditions.

The term “oil” as used herein typically refers to a lipid that is liquid at 25° C. and that is hydrophobic and soluble in organic solvents. Oil is typically composed primarily of triacylglycerols, but may also contain other neutral lipids, as well as phospholipids and free fatty acids. An oil can be from a plant, animal, or mineral source, for example.

The terms “sequence identity”, “identity” and the like as used herein with respect to a polypeptide amino acid sequence (e.g., that of a glucosyltransferase) are as defined and determined in U.S. Patent Appl. Publ. No. 2017/0002336, which is incorporated herein by reference.

Various polypeptide amino acid sequences are disclosed herein as features of certain embodiments. Variants of these sequences that are at least about 70-85%, 85-90%, or 90%-95% identical to the sequences disclosed herein can be used or referenced. Alternatively, a variant amino acid sequence can have at least 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 99.5% identity with a sequence disclosed herein. The variant amino acid sequence has the same function/activity of the disclosed sequence, or at least about 80%, 81%, 82%, 83%, 84%, 85%, 86%, 87%, 88%, 89%, 90%, 91%, 92%, 93%, 94%, 95%, 96%, 97%, 98%, or 99% of the function/activity of the disclosed sequence.

The terms “percent by volume”, “volume percent”, “vol %”, “v/v %” and the like are used interchangeably herein. The percent by volume of a solute in a solution can be determined using the formula: [(volume of solute)/(volume of solution)]×100%.

The terms “percent by weight”, “weight percentage (wt %)”, “weight-weight percentage (% w/w)” and the like are used interchangeably herein. Percent by weight refers to the percentage of a material on a mass basis as it is comprised in a composition, mixture, or solution.

The terms “weight/volume percent”, “w/V %” and the like are used interchangeably herein. Weight/volume percent can be calculated as: ((mass [g] of material)/(total volume [mL] of the material plus the liquid in which the material is placed))×100%. The material can be insoluble in the liquid (i.e., be a solid phase in a liquid phase, such as with a dispersion), or soluble in the liquid (i.e., be a solute dissolved in the liquid).

The term “isolated” means a substance (or process) in a form or environment that does not occur in nature. A non-limiting example of an isolated substance includes any alpha-glucan composition disclosed herein. It is believed that the embodiments disclosed herein are synthetic/man-made (could not have been made or practiced except for human intervention/involvement), and/or have properties that are not naturally occurring.

The term “increased” as used herein can refer to a quantity or activity that is at least about 1%, 2%, 3%, 4%, 5%, 6%, 7%, 8%, 9%, 10%, 11%, 12%, 13%, 14%, 15%, 16%, 17%, 18%, 19%, 20%, 50%, 100%, or 200% more than the quantity or activity for which the increased quantity or activity is being compared. The terms “increased”, “elevated”, “enhanced”, “greater than”, “improved” and the like are used interchangeably herein.

Some aspects of the present disclosure concern a solution (caustic solution, dope solution) comprising at least
(a) a caustic solvent,
(b) alpha-glucan and/or a derivative thereof (or alpha-glucan that was crosslinked before being entered to the caustic solvent), and
(c) an additive, wherein the additive is
   (i) a crosslinking agent (e.g., if alpha-glucan was not crosslinked before being entered to the caustic solvent), and/or
   (ii) optionally an additive that does not chemically react with the alpha-glucan or derivative thereof,
wherein at least about 50% of the glycosidic linkages of the alpha-glucan are alpha-1,3 glycosidic linkages, and the weight-average degree of polymerization of the alpha-glucan is at least 15,
wherein the alpha-glucan or derivative thereof is dissolved in the caustic solvent, and the additive is dissolved or not dissolved in the caustic solvent.

Such a caustic solution has several advantageous features. For example, it can be used to produce dope solution filaments comprising alpha-glucan herein and crosslinker (or crosslinked alpha-glucan) that are more amenable to stretching or other types of manipulation as compared to dope solution filaments lacking crosslinker or crosslinked alpha-glucan. As another example, a caustic solution herein can be used to produce a solid composition of insoluble alpha-glucan or derivative thereof in which an aqueous-soluble additive is embedded and/or adsorbed; the aqueous-soluble additive's presence is durable in that it is not readily removed by contacting the solid composition with a non-caustic aqueous liquid.

Alpha-glucan of the present disclosure typically is aqueous-insoluble under non-caustic conditions herein. In general, at least about 50% of the glycosidic linkages of alpha-glucan herein are alpha-1,3 glycosidic linkages. In some aspects, about, or at least about, 50%, 60%, 70%, 80%, 85%, 90%, 91%, 92%, 93%, 94%, 95%, 96%, 97%, 98%, 99%, 99.5%, or 100% of the glycosidic linkages of alpha-glucan are alpha-1,3 glycosidic linkages. Typically, the glycosidic linkages that are not alpha-1,3 are mostly or entirely alpha-1,6. It should be understood that the higher the percentage of alpha-1,3 linkages present in an alpha-glucan, the greater the probability that the glucan is linear, since there are lower occurrences of certain linkages that might be part of branch points. In some aspects, alpha-glucan has no branch points or less than about 5%, 4%, 3%, 2%, or 1% branch points as a percent of the glycosidic linkages in the alpha-glucan.

Alpha-glucan of the present disclosure can have a DPw, DPn, or DP of at least about 15, for example. In some aspects, the DPw, DPn, or DP of alpha-glucan can be about, less than about, at least about, or over about, 10, 15, 20, 25, 30, 35, 36, 37, 38, 39, 40, 41, 42, 43, 44, 45, 46, 47, 48, 49, 50, 51, 52, 53, 54, 55, 56, 57, 58, 59, 60, 65, 70, 75, 80, 85, 90, 95, 100, 110, 125, 150, 200, 300, 400, 500, 600, 700, 800, 900, 1000, 1100, 1200, 1300, 1400, 1500, 1600, 1700, 1800, 1900, 2000, 2500, 3000, 3500, or 4000. DPW, DPn, or DP can optionally be expressed as a range between any two of these values. Merely as examples, the DPw, DPn, or DP of alpha-glucan herein can be about 15-1600, 50-1600, 100-1600, 200-1600, 300-1600, 400-1600, 500-1600, 600-1600, 700-1600, 15-1250, 50-1250, 100-1250, 200-1250, 300-1250, 400-1250, 500-1250, 600-1250, 700-1250, 15-1000, 50-1000, 100-1000, 200-1000, 300-1000, 400-1000, 500-1000, 600-1000, 700-1000, 15-900, 50-900, 100-900, 200-900, 300-900, 400-900, 500-900, 600-900, 700-900, 600-800, or 600-750. Merely as further examples, the DPw, DPn, or DP of alpha-glucan herein can be about 15-100, 25-100, 35-100, 15-80, 25-80, 35-80, 15-60, 25-60, 35-60, 15-55, 25-55, 35-55, 15-50, 25-50, 35-50, 35-45, 35-40, 40-100, 40-80, 40-60, 40-55, 40-50, 45-60, 45-55, 45-50, 15-35, 20-35, 15-30, or 20-30. Merely as further examples, the DPW, DPn, or DP can be about 100-600, 100-500, 100-400, 100-300, 200-600, 200-500, 200-400, or 200-300. In some aspects, alpha-glucan can have a high molecular weight as reflected by high intrinsic viscosity (IV); e.g., IV can be about, or at least about, 6, 7, 8, 9, 10, 11, 12, 13, 14, 15, 16, 17, 18, 19, 20, 21, 22, 6-8, 6-7, 6-22, 6-20, 6-17, 6-15, 6-12, 10-22, 10-20, 10-17, 10-15, 10-12, 12-22, 12-20, 12-17, or 12-15 dL/g (for comparison purposes, note that the IV of insoluble alpha-glucan with at least 90% (e.g., about 99% or 100%) alpha-1,3 linkages and a DPw of about 800 has an IV of about 2-2.5 dL/g). IV herein can be as measured with insoluble alpha-glucan polymer dissolved in DMSO with about 0.9 to 2.5 wt % (e.g., 1, 2, 1-2 wt %) LiCl, for example.

Alpha-glucan herein can be as disclosed (e.g., molecular weight, linkage profile, and/or production method), for example, in U.S. Pat. Nos. 7,000,000, 8,871,474, 10301604, or 10260053, or U.S. Patent Appl. Publ. Nos. 2019/0112456, 2019/0078062, 2019/0078063, 2018/0340199, 2018/0021238, 2018/0273731, 2017/0002335, 2015/0232819, 2015/0064748, 2020/0165360, 2020/0131281, or 2019/0185893, which are each incorporated herein by reference. Alpha-glucan can be produced, for example, by an enzymatic reaction comprising at least water, sucrose and a glucosyltransferase enzyme that synthesizes the alpha-glucan. Glucosyltransferases, reaction conditions, and/or processes contemplated to be useful for producing alpha-glucan can be as disclosed in any of the foregoing references.

In some aspects, a glucosyltransferase enzyme for producing alpha-glucan herein can comprise an amino acid sequence that is 100% identical to, or at least 90%, 91%, 92%, 93%, 94%, 95%, 96%, 97%, 98%, 98.5%, 99%, or 99.5% identical to, SEQ ID NO:2, 4, 6, 8, 10, 12, 14, 16, 18, 20, 26, 28, 30, 34, or 59, or amino acid residues 55-960 of SEQ ID NO:4, residues 54-957 of SEQ ID NO:65, residues 55-960 of SEQ ID NO:30, residues 55-960 of SEQ ID NO:28, or residues 55-960 of SEQ ID NO:20, and have glucosyltransferase activity; these amino acid sequences are disclosed in U.S. Patent Appl. Publ. No. 2019/0078063, which is incorporated herein by reference. It is noted that a glucosyltransferase enzyme comprising SEQ ID NO:2, 4, 8, 10, 14, 20, 26, 28, 30, 34, or amino acid residues 55-960 of SEQ ID NO:4, residues 54-957 of SEQ ID NO:65, residues 55-960 of SEQ ID NO:30, residues 55-960 of SEQ ID NO:28, or residues 55-960 of SEQ ID NO:20, can synthesize alpha-glucan comprising at least about 90% (˜100%) alpha-1,3 linkages.

In some aspects, alpha-glucan can be in the form of a graft copolymer such as disclosed in Int. Patent Appl. Publ. No. WO2017/079595 or U.S. Patent Appl. Publ. Nos. 2020/0165360, 2019/0185893, or 2020/0131281, which are incorporated herein by reference. A graft copolymer can comprise dextran (as backbone) and alpha-1,3-glucan (as one or more side chains), where the latter component has been grafted onto the former component; typically, this graft copolymer is produced by using dextran or alpha-1,2- and/or alpha-1,3-branched dextran as a primer for alpha-1,3-glucan synthesis by an alpha-1,3-glucan-producing glucosyltransferase as described above. Alpha-1,3-glucan side chain(s) of an alpha-glucan graft copolymer herein can be alpha-1,3-glucan as presently disclosed. Dextran backbone of an alpha-glucan graft copolymer herein can comprise about 100% alpha-1,6 glycosidic linkages (i.e., completely linear dextran backbone), or about, or at least about, 80%, 85%, 90%, 95%, 96%, 97%, 98%, 99%, or 99.5% alpha-1,6 glycosidic linkages (i.e., substantially linear dextran backbone), and/or have a DP, DPw, or DPn of about, at least about, or less than about, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 85, 90, 95, 100, 105, 110, 150, 200, 250, 300, 400, 500, 600, 700, 800, 900, 1000, 8-20, 8-30, 8-100, 8-500, 3-4, 3-5, 3-6, 3-7, 3-8, 4-5, 4-6, 4-7, 4-8, 5-6, 5-7, 5-8, 6-7, 6-8, 7-8, 90-120, 95-120, 100-120, 105-120, 110-120, 115-120, 90-115, 95-115, 100-115, 105-115, 110-115, 90-110, 95-110, 100-110, 105-110, 90-105, 95-105, 100-105, 90-100, 95-100, 90-95, 85-95, or 85-90, for example. The molecular weight of a dextran backbone in some aspects can be about, or at least about, 0.1, 0.125, 0.15, 0.175, 0.2, 0.24, 0.25, 0.5, 0.75, 1, 2, 3, 4, 5, 6, 7, 8, 9, 10, 20, 30, 40, 50, 60, 70, 80, 90, 100, 110, 120, 130, 140, 150, 160, 170, 180, 190, 200, 0.1-0.2, 0.125-0.175, 0.13-0.17, 0.135-0.165, 0.14-0.16, 0.145-0.155, 5-15, 10-80, 20-70, 30-60, 40-50, 50-200, 60-200, 70-200, 80-200, 90-200, 100-200, 110-200, 120-200, 50-180, 60-180, 70-180, 80-180, 90-180, 100-180, 110-180, 120-180, 50-160, 60-160, 70-160, 80-160, 90-160, 100-160, 110-160, 120-160, 50-140, 60-140, 70-140, 80-140, 90-140, 100-140, 110-140, 120-140, 50-120, 60-120, 70-120, 80-120, 90-120, 90-110, 100-120, 110-120, 50-110, 60-110, 70-110, 80-110, 90-110, 100-110, 50-100, 60-100, 70-100, 80-100, 90-100, or 95-105 million Daltons. In some aspects, a dextran backbone (before being integrated into a graft copolymer) has been, or is, alpha-1,2- and/or alpha-1,3-branched; the percent alpha-1,2 and/or alpha-1,3 branching of a backbone of a graft copolymer herein can be about, at least about, or less than about, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 30%, 35%, 40%, 45%, 50%, 2-25%, 2-20%, 2-15%, 2-10%, 5-25%, 5-20%, 5-15%, 5-10%, 7-13%, 8-12%, 9-11%, 10-25%, 10-20%, 10-15%, 10-22%, 12-20%, 12-18%, 14-20%, 14-18%, 15-18%, or 15-17%, for example. The dextran portion of a graft copolymer herein can be as disclosed (e.g., molecular weight, linkage/branching profile, production method), for example, in U.S. Patent Appl. Publ. Nos. 2016/0122445, 2017/0218093, 2018/0282385, 2020/0165360, or 2019/0185893, which are each incorporated herein by reference. In some aspects, a dextran can be one produced in a suitable reaction comprising glucosyltransferase (GTF) 0768 (SEQ ID NO:1 or 2 of US2016/0122445), GTF 8117, GTF 6831, or GTF 5604 (these latter three GTF enzymes are SEQ ID NOs: 30, 32 and 33, respectively, of US2018/0282385), or a GTF comprising an amino acid sequence that is at least 90%, 91%, 92%, 93%, 94%, 95%, 96%, 97%, 98%, or 99% identical to the amino acid sequence of GTF 0768, GTF 8117, GTF 6831, or GTF 5604.

A caustic solution herein can comprise one, two, three, or more different alpha-glucans herein (e.g., differing in DPw and/or percent alpha-1,3 linkages).

Any alpha-glucan as presently disclosed can be derivatized and used in a caustic solution herein, or other composition herein (e.g., fiber, fibrid, composite, or film/coating). For example, the alpha-glucan portion of an alpha-glucan derivative herein can have a molecular weight (e.g., DP, DPw, or DPn) and/or glycosidic linkage profile as disclosed herein for an alpha-glucan. Merely as examples, an alpha-glucan herein that can be derivatized can comprise (i) alpha-glucan (e.g., with ≥ about 50%, 90%, 95%, 99%, or 100% alpha-1,3 linkages) with a DPw over 15 (e.g., ≥100, 400, 600), or (ii) an alpha-glucan graft copolymer herein. An alpha-glucan derivative in some aspects can have a degree of substitution (DOS) up to about 3.0 with at least one substituent (e.g., organic group) as presently disclosed. An organic group herein can be uncharged (nonionic) or charged (e.g., cationic [positively charged] or anionic [negatively charged]). The degree of substitution (DoS) in some aspects can be about, at least about, or up to about, 0.001, 0.0025, 0.005, 0.01, 0.025, 0.05, 0.075, 0.1, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 (DoS can optionally be expressed as a range between any two of these values). Some examples of DoS ranges herein include 0.001-3.0, 0.001-2.0, 0.001-1.5, 0.001-1.25, 0.001-1.0, 0.001-0.9, 0.001-0.8, 0.001-0.7, 0.001-0.6, 0.001-0.5, 0.005-3.0, 0.005-2.0, 0.005-1.5, 0.005-1.25, 0.005-1.0, 0.005-0.9, 0.005-0.8, 0.005-0.7, 0.005-0.6, 0.005-0.5, 0.01-3.0, 0.01-2.0, 0.01-1.5, 0.01-1.25, 0.01-1.0, 0.01-0.9, 0.01-0.8, 0.01-0.7, 0.01-0.6, 0.01-0.5, 0.05-3.0, 0.05-2.0, 0.05-1.5, 0.05-1.25, 0.05-1.0, 0.05-0.9, 0.05-0.8, 0.05-0.7, 0.05-0.6, 0.05-0.5, 0.1-3.0, 0.1-2.0, 0.1-1.5, 0.1-1.25, 0.1-1.0, 0.1-0.9, 0.1-0.8, 0.1-0.7, 0.1-0.6, 0.1-0.5, 0.15-3.0, 0.15-2.0, 0.15-1.5, 0.15-1.25, 0.15-1.0, 0.15-0.9, 0.15-0.8, 0.15-0.7, 0.15-0.6, 0.15-0.5, 0.2-3.0, 0.2-2.0, 0.2-1.5, 0.2-1.25, 0.2-1.0, 0.2-0.9, 0.2-0.8, 0.2-0.7, 0.2-0.6, 0.2-0.5, 0.25-3.0, 0.25-2.0, 0.25-1.5, 0.25-1.25, 0.25-1.0, 0.25-0.9, 0.25-0.8, 0.25-0.7, 0.25-0.6, 0.25-0.5, 0.3-3.0, 0.3-2.0, 0.3-1.5, 0.3-1.25, 0.3-1.0, 0.3-0.9, 0.3-0.8, 0.3-0.7, 0.3-0.6, 0.3-0.5, 0.4-3.0, 0.4-2.0, 0.4-1.5, 0.4-1.25, 0.4-1.0, 0.4-0.9, 0.4-0.8, 0.4-0.7, 0.4-0.6 and 0.4-0.5.

An alpha-glucan derivative can be used in place of, or in addition to, a non-derivatized alpha-glucan used in part (b) of a caustic solution. Also for example, an alpha-glucan derivative can be used as an additive in part (c) of a caustic solution. An alpha-glucan derivative of part (b) of a caustic solution herein typically is aqueous-insoluble under non-caustic aqueous conditions. An alpha-glucan derivative can be charged (e.g., cationic or anionic), for example (when used as an additive, such is an example of a charged additive). The degree of substitution (DoS) of a charged aqueous-insoluble-under-non-caustic-aqueous-conditions alpha-glucan derivative is typically about, or less than about, 0.29, 0.25, 0.2, 0.15, 0.1, 0.05, 0.05-0.29, 0.05-0.25, 0.05-0.2, 0.05-0.15, 0.1-0.29, 0.1-0.25, 0.1-0.2, or 0.1-0.15 (generally, a higher DoS [over 0.3 or higher] renders it as being aqueous-soluble under non-caustic aqueous conditions). In some aspects, any of the foregoing features can likewise characterize an alpha-glucan derivative used as an additive herein (part [c] of a caustic solution). The type of derivative (e.g., aqueous-insoluble or aqueous-soluble under non-caustic aqueous conditions) (e.g., for use in part [b] or part [c] of a caustic solution herein) can be any derivative as disclosed herein (e.g., ether, ester), for example.

An aqueous-soluble (under non-caustic conditions) alpha-glucan derivative in some aspects (e.g., can be an additive in part [c] of a caustic solution herein] can have a degree of substitution (DoS) up to about 3.0 (e.g., 0.3 to 3.0) with at least one organic group/substituent as presently disclosed. Such an organic group typically is charged; i.e., the organic group can be cationic or anionic. The DoS can be about, or at least about, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 (DoS can optionally be expressed as a range between any two of these values), for example. Some examples of DoS ranges herein for a soluble-alpha-glucan-derivative-under-non-caustic-aqueous-conditions include 0.3-3.0, 0.3-2.5, 0.3-2.0, 0.3-1.75, 0.3-1.5, 0.3-1.25, 0.3-1.0, 0.3-0.9, 0.3-0.8, 0.3-0.7, 0.3-0.6, 0.3-0.5, 0.4-3.0, 0.4-2.5, 0.4-2.0, 0.4-1.75, 0.4-1.5, 0.4-1.25, 0.4-1.0, 0.4-0.9, 0.4-0.8, 0.4-0.7, 0.4-0.6, 0.4-0.5, 0.5-3.0, 0.5-2.5, 0.5-2.0, 0.5-1.75, 0.5-1.5, 0.5-1.25, 0.5-1.0, 0.5-0.9, 0.5-0.8, 0.5-0.7, 0.5-0.6, 0.6-3.0, 0.6-2.5, 0.6-2.0, 0.6-1.75, 0.6-1.5, 0.6-1.25, 0.6-1.0, 0.6-0.9, 0.6-0.8, 0.6-0.7, 0.8-3.0, 0.8-2.5, 0.8-2.0, 0.8-1.75, 0.8-1.5, 0.8-1.25, 0.8-1.0, and 0.8-0.9.

Typically, an alpha-glucan derivative that is insoluble under non-caustic aqueous conditions can be used in either part (b) and/or part (c) of a caustic solution herein (if both [b] and [c], then typically two different derivatives are used). Typically, an alpha-glucan derivative that is soluble under non-caustic aqueous conditions can be used as an additive in part (c) of a caustic solution herein. In some aspects, if part (b) comprises water-insoluble alpha-glucan, then the part (c) additive comprises an alpha-glucan derivative. In some aspects, if the part (c) additive comprises an alpha-glucan derivative, then part (b) does not comprise an alpha-glucan derivative (or a polysaccharide derivative).

An alpha-glucan derivative in some aspects (e.g., either insoluble or soluble in non-caustic aqueous conditions, depending on the DoS and derivative type) is substituted with at least one organic group herein via an ether linkage, ester linkage, carbamate linkage, or sulfonyl linkage. Thus, an alpha-glucan derivative herein can be an alpha-glucan ether, ester, carbamate, or sulfonyl derivative, for example. All the various linked groups disclosed herein are examples of organic groups; an organic group can be considered to comprise at least one carbon atom and at least one hydrogen atom, for example.

An alpha-glucan derivative can be an ether derivative in some aspects.

An organic group that is in ether-linkage to an alpha-glucan herein can comprise or consist of a positively charged (cationic) group, for example. A positively charged group can be, for example, any of those disclosed in U.S. Pat. Appl. Publ. Nos. 2016/0311935 or 2020/0002646, or Int. Patent Appl. Publ. Nos. WO2021/247810 or WO2021257786, or U.S. Patent Appl. No. 63/276,163, which are incorporated herein by reference. A positively charged group can comprise a substituted ammonium group, for example. Examples of substituted ammonium groups are primary, secondary, tertiary and quaternary ammonium groups, such as can be represented by Structures I and II. An ammonium group can be substituted with alkyl group(s) and/or aryl group(s), for example. There can be one, two, or three alkyl and/or aryl groups in some aspects. An alkyl group of a substituted ammonium group herein can be a C₁-C₃₀ alkyl group, for example, such as a methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, C₂₅, C₂₆, C₂₇, C₂₈, C₂₉, or C₃₀ group; each alkyl group can be the same or different is aspects with two or three alkyl substitutions. An alkyl group can be C₁-C₂₄, C₁-C₁₈, C₆-C₂₀, C₁₀-C₁₆, or C₁-C₄ in some aspects. An aryl group can be a C₆, C₆-C₂₄, C₁₂-C₂₄, or C₆-C₁₈ aryl group, for example, that is optionally substituted with one or more alkyl substituents (e.g., any alkyl group disclosed herein).

A secondary ammonium alpha-glucan ether herein can comprise a monoalkylammonium group in some aspects (e.g., based on Structure I). A secondary ammonium alpha-glucan ether can be a monoalkylammonium alpha-glucan ether in some aspects, such as a monomethyl-, monoethyl-, monopropyl-, monobutyl-, monopentyl-, monohexyl-, monoheptyl-, monooctyl-, monononyl-, monodecyl-, monoundecyl-, monododecyl-, monotridecyl-, monotetradecyl-, monopentadecyl-, monohexadecyl-, monoheptadecyl-, or monooctadecyl-ammonium alpha-glucan ether. These alpha-glucan ethers can also be referred to as methyl-, ethyl-, propyl-, butyl-, pentyl-, hexyl-, heptyl-, octyl-, nonyl-, decyl-, undecyl-, dodecyl-, tridecyl-, tetradecyl-, pentadecyl-, hexadecyl-, heptadecyl-, or octadecyl-ammonium alpha-glucan ethers, respectively.

A tertiary ammonium alpha-glucan ether herein can comprise a dialkylammonium group in some aspects (e.g., based on Structure I). A tertiary ammonium alpha-glucan ether can be a dialkylammonium alpha-glucan ether in some aspects, such as a dimethyl-, diethyl-, dipropyl-, dibutyl-, dipentyl-, dihexyl-, diheptyl-, dioctyl-, dinonyl-, didecyl-, diundecyl-, didodecyl-, ditridecyl-, ditetradecyl-, dipentadecyl-, dihexadecyl-, diheptadecyl-, or dioctadecyl-ammonium alpha-glucan ether.

A quaternary ammonium alpha-glucan ether herein can comprise a trialkylammonium group in some aspects (e.g., based on Structure I). A quaternary ammonium alpha-glucan ether compound can be a trialkylammonium alpha-glucan ether in some aspects, such as trimethyl-, triethyl-, tripropyl-, tributyl-, tripentyl-, trihexyl-, triheptyl-, trioctyl-, trinonyl-, tridecyl-, triundecyl-, tridodecyl-, tritridecyl-, tritetradecyl-, tripentadecyl-, trihexadecyl-, triheptadecyl-, or trioctadecyl-ammonium alpha-glucan ether.

One of the groups of a substituted ammonium group comprises one carbon, or a chain of carbons (e.g., up to 30), in ether linkage to an alpha-glucan. A carbon chain in this context can be linear, for example. Such a carbon or carbon chain can be represented by —CH₂—, —CH₂CH₂—, —CH₂CH₂CH₂—, —CH₂ (CH₂)₂CH₂—, —CH₂ (CH₂)₃CH₂—, —CH₂ (CH₂)₄CH₂—, —CH₂ (CH₂)₅CH₂—, —CH₂ (CH₂)₆CH₂—, —CH₂ (CH₂)₇CH₂—, —CH₂ (CH₂)₈CH₂—, —CH₂ (CH₂)₉CH₂—, or —CH₂ (CH₂)₁₀CH₂—, for example. In some aspects, a carbon chain in this context can be branched, such as by being substituted with one or more alkyl groups (e.g., any as disclosed above such as methyl, ethyl, propyl, or butyl). The point(s) of substitution can be anywhere along the carbon chain. Examples of branched carbon chains include —CH(CH₃)CH₂—, —CH(CH₃)CH₂CH₂—, —CH₂CH(CH₃)CH₂—, —CH(CH₂CH₃)CH₂—, —CH(CH₂CH₃)CH₂CH₂—, —CH₂CH(CH₂CH₃)CH₂—, —CH(CH₂CH₂CH₃)CH₂—, —CH(CH₂CH₂CH₃)CH₂CH₂-and-CH₂CH(CH₂CH₂CH₃)CH₂—; longer branched carbon chains can also be used, if desired. In some aspects, a chain of one or more carbons (e.g., any of the above linear or branched chains) is further substituted with one or more hydroxyl groups. Examples of hydroxy- or dihydroxy (diol)-substituted chains include-CH(OH)—, —CH(OH)CH₂—, —C(OH)₂CH₂—, —CH₂CH(OH)CH₂—, —CH(OH)CH₂CH₂—, —CH(OH)CH(OH)CH₂—, —CH₂CH₂CH(OH)CH₂—, —CH₂CH(OH)CH₂CH₂—, —CH(OH)CH₂CH₂CH₂—, —CH₂CH(OH)CH(OH)CH₂—, —CH(OH)CH(OH)CH₂CH₂-and-CH(OH)CH₂CH(OH)CH₂—. In each of the foregoing examples, the first carbon atom of the chain is ether-linked to a glucose monomer of the alpha-glucan, and the last carbon atom of the chain is linked to a positively charged group (e.g., a substituted ammonium group as disclosed herein). One or more positively charged organic groups in some aspects can comprise trimethylammonium hydroxypropyl groups (Structure II, when each of R₂, R₃ and R₄ is a methyl group).

In aspects in which a carbon chain of a positively charged organic group has a substitution in addition to a substitution with a positively charged group, such additional substitution can be with one or more hydroxyl groups, oxygen atoms (thereby forming an aldehyde or ketone group), alkyl groups (e.g., methyl, ethyl, propyl, butyl), and/or additional positively charged groups, for example. A positively charged group is typically bonded to the terminal carbon atom of the carbon chain. A positively charged group can also comprise imidazoline ring-containing compounds in some aspects.

A counter ion for a positively charged organic group herein can be any suitable anion, such as an acetate, borate, bromate, bromide, carbonate, chlorate, chloride, chlorite, dihydrogen phosphate, fluoride, hydrogen carbonate, hydrogen phosphate, hydrogen sulfate, hydrogen sulfide, hydrogen sulfite, hydroxide, hypochlorite, iodate, iodide, nitrate, nitride, nitrite, oxalate, oxide, perchlorate, permanganate, phosphate, phosphide, phosphite, silicate, stannate, stannite, sulfate, sulfide, sulfite, tartrate, or thiocyanate anion.

An organic group that is in ether-linkage to an alpha-glucan herein can comprise or consist of a negatively charged (anionic) group, for example. An anionic group can be, for example, any of those disclosed in U.S. Pat. Appl. Publ. Nos. 2016/0311935 or 2020/0002646, or Int. Patent Appl. Publ. Nos. WO2021/252569 or WO2021/247810, which are incorporated herein by reference. An anionic group herein can comprise a substituted alkyl group, where the alkyl group has one, two, or more substitutions with at least one anionic group. A substituted alkyl group can be a substituted methyl, ethyl, propyl, butyl, pentyl, hexyl, heptyl, octyl, nonyl, decyl, undecyl, dodecyl, tridecanyl, tetradecanyl, pentadecanyl, hexadecanyl, heptadecanyl, or octadecanyl group. An anionic group of a substituted alkyl group can be a carboxy group, for example; i.e., an anionic group herein can comprise a carboxy alkyl group. Examples of suitable carboxy alkyl groups herein include carboxymethyl (—CH₂COOH), carboxyethyl (e.g., —CH₂CH₂COOH, —CH(COOH)CH₃), carboxypropyl (e.g., —CH₂CH₂CH₂COOH, —CH₂CH(COOH)CH₃, —CH(COOH)CH₂CH₃), carboxybutyl and carboxypentyl groups. Aside from being substituted with at least one anionic group, a substituted alkyl group can optionally be further substituted with at least one other group such as an alkyl group or hydroxyl group.

An organic group that is in ether-linkage to an alpha-glucan herein can comprise or consist of an alkyl group, for example. An alkyl group can be a linear, branched, or cyclic (“cycloalkyl” or “cycloaliphatic”) in some aspects. In some aspects, an alkyl group is a C₁ to C₁₈ alkyl group, such as a C₄ to C₁₈ alkyl group, or a C₁ to C₁₀ alkyl group (in “C_{#}”, #refers to the number of carbon atoms in the alkyl group). An alkyl group can be, for example, a methyl, ethyl, propyl, butyl, pentyl, hexyl, heptyl, octyl, nonyl, decyl, undecyl, dodecyl, tridecanyl, tetradecanyl, pentadecanyl, hexadecanyl, heptadecanyl, or octadecanyl group; such alkyl groups typically are linear. One or more carbons of an alkyl group can be substituted with another alkyl group in some aspects, making the alkyl group branched. Suitable examples of branched chain isomers of linear alkyl groups include isopropyl, iso-butyl, tert-butyl, sec-butyl, isopentyl, neopentyl, isohexyl, neohexyl, 2-ethylhexyl, 2-propylheptyl, and isooctyl. In some aspects, an alkyl group is a cycloalkyl group such as a cyclopentyl, cyclohexyl, cycloheptyl, cyclooctyl, cyclononyl, or cyclodecyl group.

Optionally, an etherified alkyl group herein can contain one or more heteroatoms such as oxygen, sulfur, and/or nitrogen within the hydrocarbon chain. Examples include alkyl groups containing an alkyl glycerol alkoxylate moiety (-alkylene-OCH₂CH(OH)CH₂OH), a moiety derived from ring-opening of 2-ethylhexl glycidyl ether, and a tetrahydropyranyl group (e.g., as derived from dihydropyran). Further examples include alkyl groups substituted at their termini with a cyano group (—C≡N); such a substituted alkyl group can optionally be referred to as a nitrile or cyanoalkyl group. Examples of a cyanoalkyl group herein include cyanomethyl, cyanoethyl, cyanopropyl and cyanobutyl groups.

In some aspects, an etherified organic group comprises or consists of a C₂ to C₁₈ (e.g., C₄ to C₁₈) alkenyl group, and the alkenyl group may be linear, branched, or cyclic. As used herein, the term “alkenyl group” refers to a hydrocarbon group containing at least one carbon-carbon double bond. Examples of alkenyl groups include ethenyl, propenyl, butenyl, pentenyl, hexenyl, cyclohexyl, and allyl groups. In some aspects, one or more carbons of an alkenyl group can have substitution(s) with an alkyl group, hydroxyalkyl group, or dihydroxy alkyl group such as disclosed herein. Examples of such a substituent alkyl group include methyl, ethyl, and propyl groups. Optionally, an alkenyl group herein can contain one or more heteroatoms such as oxygen, sulfur, and/or nitrogen within the hydrocarbon chain; for example, an alkenyl group can contain a moiety derived from ring-opening of an allyl glycidyl ether.

In some aspects, an etherified organic group comprises or consists of a C₂ to C₁₈ alkynyl group. As used herein, the term “alkynyl” refers to linear and branched hydrocarbon groups containing at least one carbon-carbon triple bond. An alkynyl group herein can be, for example, propynyl, butynyl, pentynyl, or hexynyl. An alkynyl group can optionally be substituted, such as with an alkyl, hydroxyalkyl, and/or dihydroxy alkyl group. Optionally, an alkynyl group can contain one or more heteroatoms such as oxygen, sulfur, and/or nitrogen within the hydrocarbon chain.

In some aspects, an etherified organic group comprises or consists of a polyether comprising repeat units of (—CH₂CH₂O—), (—CH₂CH(CH₃)O—), or a mixture thereof, wherein the total number of repeat units is in the range of 2 to 100. In some aspects, an organic group is a polyether group comprising (—CH₂CH₂O—)₃-100 or (—CH₂CH₂O—)₄₋₁₀₀. In some aspects, an organic group is a polyether group comprising (—CH₂CH(CH₃)O—)₃₋₁₀₀ or (—CH₂CH(CH₃)O—)₄₋₁₀₀. As used herein for a polyether group, the subscript designating a range of values designates the potential number of repeat units; for example, (CH₂CH₂O)₂₋₁₀₀ means a polyether group containing 2 to 100 repeat units. In some aspects, a polyether group herein can be capped such as with a methoxy, ethoxy, or propoxy group.

In some aspects, an etherified organic group comprises or consists of an aryl group. As used herein, the term “aryl” means an aromatic/carbocyclic group having a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl), which is optionally mono-, di-, or trisubstituted with alkyl group(s), such as a methyl, ethyl, or propyl group (or any other alkyl group herein). In some aspects, an aryl group is a C₆ to C₂₀ aryl group. In some aspects, an aryl group is a methyl-substituted aryl group such as a tolyl (—C₆H₄CH₃) or xylyl [—C₆H₃ (CH₃)₂] group. A tolyl group can be a p-tolyl group, for instance. In some aspects, an aryl group is a benzyl group (—CH₂-phenyl). A benzyl group herein can optionally be substituted (typically on its phenyl ring) with one or more of a halogen, cyano, ester, amide, ether, alkyl (e.g., C₁ to C₆), aryl (e.g., phenyl), alkenyl (e.g., C₂ to C₆), or alkynyl (e.g., C₂ to C₆) group.

An alpha-glucan ether in some aspects can contain one type of etherified organic group herein. Yet, in some aspects, an alpha-glucan ether can contain two or more different types of etherified organic groups herein (i.e., mixed ether of the alpha-glucan). Examples of such alpha-glucan ethers contain (i) two different alkyl groups as etherified organic groups, (ii) an alkyl group and a hydroxy alkyl group as etherified organic groups (alkyl hydroxyalkyl alpha-glucan), (iii) an alkyl group and a carboxy alkyl group as etherified organic groups (alkyl carboxyalkyl alpha-glucan), (iv) a hydroxy alkyl group and a carboxy alkyl group as etherified organic groups (hydroxyalkyl carboxyalkyl alpha-glucan), (v) two different hydroxy alkyl groups as etherified organic groups, (vi) two different carboxy alkyl groups as etherified organic groups, (vii) a carboxy alkyl group and an aryl (e.g., benzyl) group. Non-limiting examples of some of these types of mixed ethers include ethyl hydroxyethyl alpha-glucan, hydroxyalkyl methyl (e.g., hydroxypropyl methyl) alpha-glucan, carboxymethyl hydroxyethyl alpha-glucan, carboxymethyl hydroxypropyl alpha-glucan and carboxymethyl benzyl alpha-glucan. A mixed alpha-glucan ether can be, in some instances, as disclosed in U.S. Patent Appl. Publ. No. 2020/0002646, which is incorporated herein by reference.

An alpha-glucan derivative can be an ester derivative in some aspects. Acyl groups of an alpha-glucan ester derivative herein can be as disclosed, for example, in U.S. Patent Appl. Publ. Nos. 2014/0187767, 2018/0155455, or 2020/0308371, or Int. Patent Appl. Publ. No. WO2021/252575, which are each incorporated herein by reference.

An alpha-glucan derivative herein can be an alpha-glucan carbamate in some aspects. An alpha-glucan carbamate derivative can comprise, for example, a carbamate group derived from an aliphatic, cycloaliphatic, or aromatic monoisocyanate. In some aspects, a substituent of an alpha-glucan carbamate derivative can be a carbamate-linked phenyl, benzyl, diphenyl methyl, or diphenyl ethyl group; these groups can optionally be derived, respectively, using an aromatic monoisocyanate such as phenyl, benzyl, diphenyl methyl, or diphenyl ethyl isocyanate. In some aspects, a substituent of an alpha-glucan carbamate derivative can be a carbamate-linked ethyl, propyl, butyl, tert-butyl, pentyl, hexyl, heptyl, octyl, nonyl, decyl, undecyl, or octadecyl group; these groups can optionally be derived, respectively, using an aliphatic monoisocyanate such as ethyl, propyl, butyl, tert-butyl, pentyl, hexyl, heptyl, octyl, nonyl, decyl, undecyl, or octadecyl isocyanate. In some aspects, a substituent of an alpha-glucan carbamate derivative can be a carbamate-linked cyclohexyl, cycloheptyl, or cyclododecyl group; these groups can optionally be derived, respectively, using a cycloaliphatic monoisocyanate such as cyclohexyl, cycloheptyl, or cyclododecyl isocyanate.

Carbamate groups of an alpha-glucan carbamate derivative herein can be as disclosed, for example, in Int. Pat. Appl. Publ. Nos. WO2020/131711 or WO2021/252569, or U.S. Pat. Appl. Publ. No. 2022/0033531, which are each incorporated herein by reference.

An alpha-glucan derivative can be an alpha-glucan sulfonyl derivative in some aspects. Sulfonyl groups of an alpha-glucan sulfonyl derivative herein can be as disclosed, for example, in Int. Pat. Appl. Publ. No. WO2021/252569, which is incorporated herein by reference.

An alpha-glucan derivative in some aspects can have carboxylate (carboxylic acid) groups. A carboxylic acid group can exist by itself (e.g., carbon 6 of glucose can be —COOH), or via an organic group that is (i) ether-, ester-, carbamate, or sulfonyl-linked to an alpha-glucan and (ii) comprises a carboxylic acid group (e.g., a carboxy alkyl group such as carboxymethyl), for example. In some aspects, a carboxylic group can be introduced (e.g., at carbon 6 of glucose and/or at a carbon of a substituent group) by oxidizing alpha-glucan or an alpha-glucan derivative; oxidation can be performed via a process as disclosed, for example, in Canadian Patent Publ. Nos. 2028284 or 2038640, or U.S. Pat. Nos. 4,985,553, 2,894,945, 5,747,658, or 7595392, or U.S. Pat. Appl. Publ. Nos. 2015/0259439, 2018/0022834, or 2018/0079832, or U.S. Pat. Appl. Nos. 63/151,223 or 63/151,237, or Int. Pat. Appl. Publ. Nos. WO2022/178075 or WO2022/178073, each of which are incorporated herein by reference.

A polysaccharide other than an alpha-1,3-glucan as presently disclosed can be derivatized and used herein, accordingly. Such derivatization can be as disclosed above (e.g., DoS, derivative type, substituent [s]), for example. A non-derivatized polysaccharide can be used in some additional or alternative aspects. A polysaccharide in some aspects can be a fructan, galactan, mannan, arabinan, xylan, soy polysaccharide, chitosan, chitin, glycosaminoglycan (e.g., heparan sulfate, dermatan sulfate, heparin), glucosamine, carrageenan, alginate, xanthan, guar, cyclodextrin, gellan, curdlan, beta-glucan (e.g., beta-1,4-glucan [cellulose], beta-1,3-glucan), or an alpha-glucan that is not an alpha-1,3-glucan herein (e.g., alpha-1,6-glucan optionally with alpha-1,2 and/or alpha-1,3 branches, alpha-1,4-glucan, alternan, reuteran, pullulan). A polysaccharide derivative and/or non-derivatized form thereof can be used as an additive (part c) in some aspects, while in some aspects a polysaccharide derivative and/or non-derivatized form thereof (e.g., beta-1,4-glucan [cellulose]) is not used as an additive.

A caustic solution herein can comprise one, two, three, or more different alpha-glucan derivatives herein (e.g., differing in DPw, percent alpha-1,3 linkages, substituent, and/or DoS). A caustic solution in some aspects does not comprise an alpha-glucan derivative herein such as an ether or ester.

Any of the foregoing polysaccharide derivatives (e.g., alpha-glucan derivatives) can be used as an additive in a solid composition of the disclosure, for example. In some aspects in which the additive is an alpha-glucan derivative, its alpha-glucan portion (i.e., as it existed before derivatization) can have the same (or similar, e.g., ±1%, 2%, or 3%) linkage and molecular weight profile as the non-derivatized alpha-glucan component.

A caustic solvent of the present disclosure typically can dissolve an aqueous-insoluble alpha-glucan and/or derivative thereof of part (b) of a caustic solution herein. A caustic solvent is aqueous in some aspects. An aqueous caustic solvent can comprise an alkali hydroxide, for example. An alkali hydroxide can comprise at least one metal hydroxide (e.g., NaOH, KOH, LiOH) or organic hydroxide (e.g., tetraethyl ammonium hydroxide). An aqueous caustic solvent can be as disclosed, for example, in Int. Pat. Appl. Publ. Nos. WO2015/200612 or WO2015/200590, or U.S. Pat. Appl. Publ. Nos. 2017/0208823 or 2017/0204203, which are each incorporated herein by reference. Typically, an aqueous-insoluble alpha-glucan and/or a derivative thereof of part (b) of a caustic solution herein is not dispersed in a caustic solvent, or is otherwise not undissolved in the solvent. The agent(s) of a solvent herein that renders it to be caustic (e.g., NaOH) should not be considered as an additive (part [c]) of the present disclosure.

In some aspects, an aqueous caustic solvent comprises one or more alkali hydroxides dissolved in water. The concentration of the alkali hydroxide(s) can be about, or at least about, 3, 4, 5, 6, 7, 8, 9, 10, 11, 12, 13, 14, 15, 3-15, 3-12, 3-10, 3-8, 3-7, 3-6, 3-5, 3-4.5, 4-15, 4-12, 4-10, 4-8, 4-7, 4-6, 4-5, or 4-4.5 wt %, for example.

The pH of a caustic solution herein and/or its caustic solvent can be about, or at least about, 10.5, 10.75, 11.0, 11.5, 12.0, 12.5, 13.0, 10.5-13.0, 10.5-12.5, 10.75-13.0, 10.75-12.5, 11.0-13.0, 11.0-12.5, 11.5-13.0, 11.5-12.5, 12.0-13.0, 12.0-12.5, or 12.5-13.0, for example. The temperature of a caustic solution herein can be about, or at least about, 1, 5, 10, 15, 20, 25, 30, 35, 40, 45, 50, 60, 70, 80, 90, 100, 110, 1-70, 1-60, 1-50, 1-45, 1-40, 1-35, 1-30, 1-25, 1-20, 15-70, 15-60, 15-50, 15-45, 15-40, 15-35, 15-30, 15-25, 15-20, 20-70, 20-60, 20-50, 20-45, 20-40, 20-35, 20-30, 20-25, 5-30, 10-30, 5-25, or 10-25° C., for example.

The concentration of an alpha-glucan and/or an alpha-glucan derivative in a caustic solution herein can be about, or at least about, 1, 2, 3, 4, 5, 6, 7, 8, 9, 10, 11, 12, 13, 14, 15, 16, 17, 18, 19, 20, 21, 22, 23, 24, 25, 5-20, 5-17.5, 5-15, 5-12.5, 5-10, 7.5-20, 7.5-17.5, 7.5-15, 7.5-12.5, 7.5-10, 10-20, 10-17.5, 10-15, 10-12.5, 12.5-20, 12.5-17.5, or 12.5-15 wt %, for example.

A composition as presently disclosed, such as a caustic solution or any other composition herein (e.g., fiber, fibrid, composite, or film/coating), can comprise about 0.1 to about 200 wt % of one or more additives, wherein this wt % is based on (relative to) the weight of the alpha-glucan and/or an alpha-glucan derivative in the caustic solution (part b) or composition. In some aspects, a composition comprises about 0.05, 0.1, 0.5, 0.75 1, 2, 3, 4, 5, 6, 7, 8, 9, 10, 11, 12, 13, 14, 15, 16, 17, 18, 19, 20, 25, 30, 35, 40, 45, 50, 75, 100, 125, 150, 175, 200, 1-200, 1-175, 1-150, 1-125, 25-200, 25-175, 25-150, 25-125, 50-200, 50-175, 50-150, 50-125, 75-200, 75-175, 75-150, 75-125, 100-200, 100-175, 100-150, 100-125, 0.1-50, 1-30, 1-25, 1-20, 1-15, 1-10, 3-30, 3-25, 3-20, 3-15, 3-10, 10-30, 10-25, 10-20, 10-15, 3-7, 4-6, 8-12, 9-11, 22-28, 23-27, 0.05-1, 0.05-0.75, 0.05-0.5, 0.05-0.25, 0.1-1, 0.1-0.75, 0.1-0.5, 0.1-0.25, 0.25-1, 0.25-0.75, 0.25-0.5, 0.05-50, 0.05-25, 0.05-20, 0.05-15, 0.05-10, 0.1-50, 0.1-25, 0.1-20, 0.1-15, 0.1-10, 0.5-50, 0.5-25, 0.5-20, 0.5-15, 0.5-10, 1-50, 1-25, 1-20, 1-15, 1-10, 2.5-50, 2.5-25, 2.5-20, 2.5-15, 2.5-10, 5-50, 5-25, 5-20, 5-15, or 5-10 wt % of one or more additives, wherein this wt % is based on the weight of the one or more insoluble alpha-glucans in the composition.

The amount of time that a caustic solution can have existed (i.e., age) upon combining all of its components (at least a caustic solvent, an alpha-glucan and/or alpha-glucan derivative, and an additive) can be about, or at least about, 0.25, 0.5, 0.75. 1, 1.25, 1.5, 2, 2.5, 3, 4, 5, 6, 7, 8, 9, 10, 20, 30, 40, 50, 75, 100, 150, 200, 0.5-3, 0.5-2.5, 0.5-2, 0.5-1.5, 0.5-1.25, 0.75-3, 0.75-2.5, 0.75-2, 0.75-1.5, or 0.75-1.25 days, for example.

A caustic solution in some aspects can have an elastic modulus (G′) of about, or at least about, 4, 5, 6, 8, 10, 20, 30, 40, 50, 60, 70, 80, 90, 100, 110, 120, 4-120, 4-110, 4-100, 4-90, 10-120, 10-110, 10-100, 10-90, 50-120, 50-110, 50-100, 50-90, 70-120, 70-110, 70-100, or 70-90 Pascals (Pa). A caustic solution in some aspects can have a viscous modulus (G″) of about, or at least about, 35, 40, 50, 75, 100, 125, 150, 175, 200, 35-200, 35-175, 35-150, 40-200, 40-175, 40-150, 100-200, 100-175, 100-150, 125-200, 125-175, or 125-150 Pascals (Pa). Elastic modulus (G′) and/or viscous modulus (G″) herein can be as measured according to the below Examples (e.g., where each condition/parameter is conducted within 5%, 10%, or 15% of the relevant condition/parameter disclosed in the Examples).

An additive herein, such as for part (c) of a caustic solution or for any other composition herein (e.g., fiber, fibrid, composite, film/coating, or powder), can comprise or consist of one or more crosslinking agents in some aspects. Examples of crosslinking agents herein include phosphoryl chloride (POCl₃), polyphosphate, sodium trimetaphosphate (STMP), boron-containing compounds (e.g., boric acid, diborates, tetraborates such as tetraborate decahydrate, pentaborates, polymeric compounds such as Polybor®, alkali borates), polyvalent metals (e.g., titanium-containing compounds such as titanium ammonium lactate, titanium triethanolamine, titanium acetylacetonate, or polyhydroxy complexes of titanium; zirconium-containing compounds such as zirconium lactate, zirconium carbonate, zirconium acetylacetonate, zirconium triethanolamine, zirconium diisopropylamine lactate, or polyhydroxy complexes of zirconium), glyoxal, glutaraldehyde, aldehyde, polyphenol, divinyl sulfone, epichlorohydrin, polyamide-epichlorohydrin (PAE), di- or poly-carboxylic acids (e.g., citric acid, malic acid, tartaric acid, succinic acid, glutaric acid, adipic acid), dichloro acetic acid, polyamines, 1,2,7,8-diepoxyoctane, diethylene glycol dimethyl ether (diglyme), diglycidyl ether (e.g., diglycidyl ether itself, ethylene glycol diglycidyl ether [EGDGE], 1,4-butanediol diglycidyl ether [BDGE], polyethylene glycol diglycidyl ether [PEGDE, such as PEG2000DGE], bisphenol A diglycidyl ether [BADGE]), and triglycidyl ether (e.g., trimethylolpropane triglycidyl ether). Still other examples of suitable crosslinking agents are described in U.S. Pat. Nos. 4,462,917, 4,464,270, 4,477,360, or 4799550, or U.S. Patent Appl. Publ. No. 2008/0112907, which are each incorporated herein by reference. In some aspects, a crosslinking agent is not a boron-containing compound (e.g., as described above). A crosslinker herein typically can dissolve in a caustic solvent and act to crosslink alpha-glucan and/or alpha-glucan derivative molecules that are also dissolved in the caustic solvent. Such crosslinking typically is covalent; i.e., alpha-glucan molecules and/or alpha-glucan derivative molecules are chemically crosslinked with each other (via intermolecular crosslinks). Thus, in some aspects, a caustic solution can be characterized to comprise crosslinked alpha-glucan and/or crosslinked alpha-glucan derivative, wherein such crosslinked material optionally is produced using any crosslinker as presently disclosed. In some aspects, alpha-glucan and/or alpha-glucan derivative is crosslinked (optionally using a crosslinker as presently disclosed) before it is entered into a caustic solvent to produce a caustic solution herein. Optionally, there are no other additives, or less than 0.1 wt % other additives, in aspects herein comprising a crosslinker or crosslinked alpha-glucan and/or alpha-glucan derivative.

The concentration of one or more crosslinkers in a caustic solution herein can be about, at least about, or less than about, 0.005, 0.01, 0.025, 0.05, 0.1, 0.25, 0.5, 0.75, 1.0, 1.25, 1.5, 2.0, 3.0, 4.0, 5.0, 7.5, 10, 0.005-0.25, 0.005-0.20, 0.005-0.15, 0.005-0.10, 0.005-0.05, 0.005-0.01, 0.01-0.25, 0.01-0.20, 0.01-0.15, 0.01-0.10, 0.01-0.05, 0.1-3.0, 0.1-2.0, 0.1-1.5, 0.1-1.25, 0.1-1.0, 0.5-3.0, 0.5-2.0, 0.5-1.5, 0.5-1.25, or 0.5-1.0 wt %, for example, wherein this wt % is based on (relative to) the weight of the alpha-glucan and/or an alpha-glucan derivative in the caustic solution (part b). Such a concentration can typically be characterized as an initial concentration (e.g., calculated concentration based on amount of crosslinker added), as the concentration of free crosslinker typically decreases as the alpha-glucan and/or alpha-glucan derivative become crosslinked by the crosslinker.

Crosslinked alpha-glucan and/or crosslinked alpha-glucan derivative of the present disclosure typically is/are soluble in a caustic solvent herein, while typically being insoluble in a non-caustic aqueous solvent (e.g., water alone). All of, or most of (e.g., at least about 70%, 75%, 80%, 85%, 90%, or 95% complete), crosslinking herein (e.g., as measured by maximal reduction in free crosslinker concentration) typically occurs in a caustic solution prior to setting the solution into a desired shape/product (e.g., fiber, fibrid, film/coating/layer, composite).

An additive herein, such as for part (c) of a caustic solution or any other composition herein (e.g., fiber, fibrid, composite, film/coating, or powder), can optionally be referred to as “another ingredient” or “another component”, for example (where the first, or other, ingredient/component is one or more alpha-glucan or alpha-glucan derivative compounds). An additive, aside from aspects in which the additive is a crosslinker, typically does not chemically react with an alpha-glucan or alpha-glucan derivative and so does not chemically modify or derivatize it in any way that results in a compound that is different from the alpha-glucan or alpha-glucan derivative as it/they existed before addition of the additive(s) (e.g., such an additive does not serve to substitute any hydrogens of glucose monomeric unit hydroxyl groups of the alpha-glucan or alpha-glucan derivative; e.g., such an additive does not change the molecular formula of the alpha-glucan or alpha-glucan derivative). There can be one, two, three, four, or more additives in some aspects. An additive can be soluble or insoluble in a caustic solution. An additive can be soluble or insoluble in a non-caustic aqueous solvent (e.g., water alone).

An additive herein can be any compound of the present disclosure. The disclosure of an additive herein typically is with regard to its state of existence before being used to prepare a composition herein (i.e., the state in which an additive would be provided before mixing with other components herein). In some aspects, an additive comprises or consists of a non-aqueous liquid and/or a hydrophobic or non-polar liquid or composition. A non-aqueous liquid can be polar or non-polar (apolar), for example. An additive in some aspects can comprise or consist of a solid material; such an additive can optionally be in an aqueous liquid or non-aqueous liquid. An additive can have neutral, negative (anionic), or positive (cationic) charge, for example; i.e., an additive can be charged. Examples of charged additives include charged polysaccharides and charged polysaccharide derivatives (e.g., polysaccharide ethers) (e.g., soluble or insoluble forms of these), such as any as disclosed herein (e.g., regarding an alpha-glucan, wherein at least about 50% of the glycosidic linkages of the alpha-glucan are alpha-1,3 glycosidic linkages, and the weight-average degree of polymerization of the alpha-glucan is at least 15). An additive can be any ingredient/component typically used in a personal care product, pharmaceutical product, household care product, industrial product, ingestible product, film/coating, composite, latex/dispersion/emulsion, encapsulant, detergent composition (e.g., fabric care, dish care), oral care, or builder composition, for example. As examples, an additive herein can be an oil such as mineral oil, silicone oil (e.g., dimethicone/polydimethylsiloxane, hexamethyldisiloxane), paraffin oil, or plant/vegetable oil (e.g., linseed oil, soybean oil, palm oil, coconut oil, canola oil, corn oil, sunflower oil, grape seed oil, cocoa butter, olive oil, rice bran oil, rapeseed oil, peanut oil, sesame oil, cottonseed oil, palm kernel oil); shortening (e.g., vegetable shortening); lipid; fat (e.g., lard, tallow, animal fat); glyceride (e.g., tri-, di- and/or mono-glyceride; e.g., caprylic/capric triglyceride); glycerol (or other polyol such as low molecular weight polyol); fatty acid; fatty aldehyde, fatty alcohol, fatty acid ester (e.g., sorbitan oleate); fatty acid amide (e.g., ethylene bis(stearamide)); wax (e.g., paraffin wax, carnauba wax); phospholipid; sterol; alkane; alkene/olefin; petrolatum (i.e., petroleum jelly); grease; detergent; anionic detergent (e.g., lauryl sulfate, alkylbenzene sulfonate); cationic detergent; non-ionic or zwitterionic detergent (e.g., polyoxyethylene-based detergent such as Tween or Triton [ethoxylates], glycoside-based detergents such as octyl thioglucoside maltoside, CHAPS); or any epoxidized versions of these; or any similar compound such as disclosed in U.S. Patent Appl. Publ. Nos. 2009/0093543 (e.g., Table 2 therein) or 2019/0144897, which are incorporated herein by reference. As examples, an additive herein can be a sugar alcohol (e.g., mannitol, sorbitol, xylitol, lactitol, isomalt, maltitol, hydrogenated starch hydrolysate), polymeric polyol (e.g., polyether polyol, polyester polyol, polyethylene glycol, polyvinyl alcohol), aprotic solvent (e.g., a polar aprotic solvent such as acetone or propylene carbonate), protic solvent (e.g., isopropanol, ethanol, methanol), hardener (e.g., active halogen compound, vinylsulfone, epoxy), resin (typically uncured) (e.g., synthetic resin such as epoxy or acetal resin; natural resin such as plant resin [e.g., pine resin], insect resin [e.g., shellac], or bitumin), or propanediol. Merely as examples, an additive herein can be a fragrance/scent (e.g., hydrophobic aroma compound, or any as disclosed in U.S. Pat. No. 7,196,049, which is incorporated herein by reference), ingestible product, food, beverage, flavor (e.g., any as disclosed in U.S. Pat. No. 7,022,352, which is incorporated herein by reference), hydrophobic flavorant or nutrient (e.g., a vitamin such as vitamin A, D, E, or K), or dye (e.g., oil-soluble dye such as Sudan red). As examples, an additive herein can be polyurethane, polyvinyl acetate, poly acrylate, poly lactic acid, polyvinylamine, polycarboxylate, a polysaccharide herein other than a water-insoluble alpha-glucan having at least 50% alpha-1,3 glycosidic linkages, a polysaccharide derivative herein (water-soluble or water-insoluble) such as a derivative of a water-insoluble alpha-glucan having at least 50% alpha-1,3 glycosidic linkages as presently disclosed (in some aspects, if an additive is an alpha-1,3-glucan derivative, a composition herein comprises a non-derivatized water-insoluble alpha-1,3-glucan as another component, such as for part [b] of a caustic solution or a product made therefrom) or any other polysaccharide derivative herein, gelatin, melamine, inorganic filler material (e.g., carbon black, a silicate such as sodium silicate, talk, chalk, a clay such as bentonite clay, or a carbonate such as calcium carbonate, calcium-magnesium carbonate, sodium percarbonate, sodium carbonate, sodium bicarbonate, ammonium bicarbonate, barium carbonate, magnesium carbonate, potassium carbonate, or iron[II] carbonate), penetrant (e.g., 1,2-propanediol, triethyleneglycol butyl ether, 2-pyrrolidone), biocide (e.g., metaborate, thiocyanate, sodium benzoate, benzisothiaolin-3-one), yellowing inhibitor (e.g., sodium hydroxymethyl sulfonate, sodium p-toluenesulfonate), ultraviolet absorbers (e.g., benzotriazole compound), antioxidant (e.g., sterically hindered phenol compound), water-resistance agent (e.g., ketone resin, anionic latex, glyoxal), or binder (e.g., polyvinyl alcohol, polyvinyl acetate, partially saponified polyvinyl acetate, silanol-modified polyvinyl alcohol, polyurethane, starch, corn dextrin, carboxymethyl cellulose, cellulose ether, hydroxyethyl cellulose, hydroxypropyl cellulose, ethylhydroxyethyl cellulose, methyl cellulose, alginate, sodium alginate, xanthan, carrageenan, casein, soy protein, guar gum, styrene butadiene latex, styrene acrylate latex. In some aspects, an additive can be a bleaching agent (e.g., chlorine-based bleach such as sodium hypochlorite or chlorinated lime; peroxide-based bleach such as hydrogen peroxide, sodium percarbonate, peracetic acid, benzoyl peroxide, or potassium permanganate). In some aspects, an additive can be characterized/categorized as follows: amphiphilic material (e.g., surfactants such as lauryl sulfate; polymeric surfactants such as polyethylene glycol or polyvinyl alcohol; particles such as silica), aqueous-insoluble small molecules (e.g., mineral oil; silicone oil; natural oil such as linseed, soybean, palm, or coconut oil), aqueous-insoluble polymeric molecules (e.g., polyacrylate, polyvinylacetate, poly lactic acid), aqueous-miscible small molecules (e.g., protic solvents such as isopropanol, ethanol, or methanol; polar aprotic solvents such as acetone or propylene carbonate; low molecular weight polyols such as glycerol; sugar alcohols), or water-miscible polymeric molecules (e.g., a polyol). In some aspects, an additive can be an alkyl ketene dimer (AKD), alkenyl succinic anhydride (e.g., octenyl succinic anhydride), epoxy compound (e.g., epoxidized linseed oil or a di-epoxy), phenethyl alcohol, undecyl alcohol, or tocopherol. An additive in some aspects can be an elastomer. An additive in some aspects can be a rubber or any other diene-based elastomer. Examples of rubber herein include natural rubber (NR) (e.g., NR latex) and synthetic rubber. Examples of synthetic rubber herein include synthetic polyisoprene, polybutadiene, styrene-butadiene copolymer, styrene-isoprene copolymer, butadiene-isoprene copolymer, styrene-butadiene-isoprene terpolymer, ethylene propylene diene monomer rubber, hydrogenated nitrile butadiene rubber, silicone rubber, and neoprene, which are also examples of diene-based elastomers. Rubber is not diene-based in some aspects, such as silicone rubber. In some aspects, an additive is not rubber. In some aspects, an additive comprises an oil or any other hydrophobic solvent herein in which a hydrophobic substance (e.g., any as disclosed herein such as a hydrophobic fragrance, flavor, nutrient, or dye) has been dissolved. An additive herein typically is not only a salt (salt ion) or buffer such as Nat, CI—, NaCl, phosphate, tris, or any other salt/buffer such as disclosed in U.S. Patent Appl. Publ. Nos. 2014/179913, 2016/0304629, 2016/0311935, 2015/0239995, 2018/0230241, or 2018/0237816, which are incorporated herein by reference. An additive can be any as disclosed in U.S. Patent Appl. Publ. No. 2019/0153674 (incorporated herein by reference), for example.

In some aspects, an additive is a water-insoluble polysaccharide (e.g., any herein such as cellulose), and remains in an undissolved state throughout a process herein of producing a solid composition (i.e., the insoluble polysaccharide does not dissolve in the selected caustic solution). A solid composition in such aspects comprises the water insoluble polysaccharide additive in a dispersed manner (i.e., the solid composition is a solid sol), rather than a homogeneous manner that would have resulted if the water-insoluble polysaccharide dissolved in the selected caustic solution.

An additive is hydrophobic in some aspects (e.g., any of the above that are hydrophobic/apolar/non-polar). A hydrophobic additive is a liquid (e.g., at a temperature disclosed herein, e.g., 10-60, 15-60, 20-60, 25-60, 30-60, 10-55, 15-55, 20-55, 25-55, 30-55, 10-50, 15-50, 20-50, 25-50, 30-50, 10-45, 15-45, 20-45, 25-45, 30-45, 10-40, 15-40, 20-40, 25-40, or 30-40° C.) and not miscible in an aqueous composition (i.e., aqueous-insoluble) (e.g., in caustic or non-caustic aqueous conditions herein), for example. A liquid hydrophobic additive can be oil, for example, such as an oil disclosed herein. In some aspects, a hydrophobic additive is a solid (e.g., at a temperature disclosed herein) and not dissolvable in an aqueous composition (e.g., caustic or non-caustic aqueous conditions herein). A solid hydrophobic additive can be wax or grease, for example. In some aspects, a solid hydrophobic additive has a melting point of about, or at least about, 45, 46, 48, 50, 52, 54, 56, 58, 60, 62, 64, 66, 68, 70, 75, 80, 85, 90, 95, 100, 45-70, 45-65, 50-70, or 50-65° C.

In some aspects, an emulsion aid (emulsion stabilizer) can be used for preparing an emulsion of a liquid additive in a caustic solvent. Examples of emulsion aids include surfactants (e.g., anionic surfactants such as sodium dodecyl sulfate) and polyelectrolytes (e.g., anionic polyelectrolytes). An emulsion stabilizer herein can be included at about 0.001-0.01, 0.004-0.006, or 0.005 wt % in a caustic solvent herein, for example.

A caustic solution of the present disclosure can be in the form of (shape of) a filament (dope filament), film/coating, or other three-dimensional material in some aspects (e.g., fibrid, composite). Such a form can be, for example, as the caustic solution exists just prior to removing the caustic solvent therefrom to render a solid material (e.g., fiber, film/coating, fibrid, composite).

Some aspects of the present disclosure regard a method of producing a caustic solution herein. Such a method can comprise, for example: mixing at least (i) an alpha-glucan and/or alpha-glucan herein, and (ii) an additive herein, with a (into a) caustic solvent, wherein the alpha-glucan and/or derivative thereof dissolves in the caustic solvent. The additive dissolves in the caustic solvent in some aspects, but remains undissolved (e.g., is dispersed) in some other aspects.

Some aspects of the present disclosure regard a method of producing a solid composition. Such a method can comprise, for example: (a) providing a caustic solution herein, (b) putting (setting/placing/forming/extruding) the caustic solution into a desired form (e.g., a fiber, film/coating, fibrid, or composite; e.g., an extruded and/or stretched form, which can optionally be a fiber, film, or composite), and (c) removing the caustic solvent from the caustic solution of step (b) to produce a solid composition comprising the alpha-glucan or derivative thereof, and the additive. The solid composition as produced from step (c) can be in the form/shape of a fiber (e.g., filament), fibrid, extrusion, composite, or film/coating (or any form made by having extruded and/or stretched the caustic solution before step [c], such as a fiber or film), for example. Such a method can optionally be characterized herein as a forming method or setting method. Some aspects herein are drawn to a composition/product comprising a solid composition produced by a method/process as presently disclosed.

In some aspects, step (b) of putting a caustic solution into a desired form can comprise using a device with one or more orifices (e.g., holes, nozzles, or perforations) through which the caustic solution is transited (emitted/ejected/pushed) through. Such processing can optionally be characterized as extruding. An example of a suitable device for performing step (b) in this manner is a spinneret. The shape of caustic solution as processed by an extrusion in step (b) can be a fiber (e.g., filament), film, or composite, for example; such a shape typically likewise characterizes the product produced in step (c). In some aspects, a fiber form (dope filament/fiber) can be air-drawn, for example using a spinneret, die, or similar device, optionally with (i) an air flow pressure of about, or up to about, 10, 20, 30, 40, 50, 60, 70, 80, 90, 100, 10-100, 10-90, 10-80, 10-70, 20-100, 20-90, 20-80, 20-70, 30-100, 30-90, 30-80, 30-70, 40-100, 40-90, 40-80, or 40-70 mbar, (ii) an extrusion speed of about, at least about, or up to about, 8, 9, 10, 11, 12, 13, 14, 15, 16, 17, 18, 19, 20, 8-20, 8-15, 10-20, 10-15, 12-20, or 12-15 m/min, and/or (iii) a spinning speed of about, at least about, or up to about, 10, 15, 20, 25, 30, 35, 40, 10-40, 10-35, 10-30, 15-40, 15-35, 15-30, 20-40, 20-35, or 20-30 m/min. The diameter (longest diameter) of one or more orifices of a device through which a caustic solution is transited through can be about, at least about, or up to about, 30, 40, 50, 60, 70, 80, 90, 30-90, 30-80, 30-70, 40-90, 40-80, 40-70, 50-90, 50-80, 50-70, or 55-65 microns, for example. An orifice herein can have a cross-section that is circular, oval, square, or rectangular, for instance. Continuous dope filaments can be produced in some aspects; such dope filaments are not subject to constant, repeated, or serial breakage or other disruption following their transition from an orifice. Step (b) of putting a caustic solution into a desired form can optionally further comprise stretching a caustic solution, such as after it has been extruded; stretching can optionally be used to reduce the diameter of an extruded caustic solution such as a dope filament. In some aspects, a dope filament has a diameter (longest diameter) that is about, or at least about, 10%, 20%, 30%, 40%, 50%, 60%, 10-60%, 10-50%, 10-40%, 10-30%, 10-20%, 20-60%, 20-50%, 20-40%, or 20-30% less than the diameter of the orifice (e.g., herein) used to extrude the dope used to make the dope filament.

The amount of caustic solvent that is removed in step (c) of a forming method can be about, or at least about, 80%, 85%, 90%, 95%, 96%, 97%, 98%, 99%, 99.5%, 99.9%, 100%, 80-100%, 90-100%, 95-100%, or 98-100% by weight of the caustic solvent that was present before performing step (c), for example.

In some aspects of a forming method, step (c) of removing the caustic solvent can comprise chemically or ionically modifying the caustic solvent (or the caustic solution) such that the alpha-glucan or alpha-glucan derivative, and the additive if it was dissolved in the caustic solvent, is/are no longer dissolved in the caustic solvent. This can be conducted by a coagulation process and/or neutralization process, for example. It is noted that, when a caustic solution herein comprises crosslinked alpha-glucan or alpha-glucan derivative, coagulation or neutralization is not necessary to retain the shape of the caustic solution form produced in step (b), but such a process can be applied to crosslinked material if desired (at least for purposes of neutralization, for example). In some aspects, typically those in which a crosslinker is not used, coagulation or neutralization is used to allow the form/shape produced in step (b) to be free-standing. To conduct step (c), for example, a form/shape produced in step (b) can be contacted with (e.g., immersed/bathed in, sprayed with, or otherwise exposed to) a coagulation/neutralization medium (e.g., liquid or aerosol form) for a suitable amount of time and/or at a temperature of below about 60, 70, or 80° C. (e.g., about room temperature [˜20-25° C.] to about 80° C.). A coagulation/neutralization medium typically comprises at least one non-solvent for the alpha-glucan or alpha-glucan derivative (and optionally the additive), such as alcohol (e.g., methanol, ethanol, propanol), water, acid, or a mixture thereof. An acid for a coagulation/neutralization medium can be sulfuric acid, acetic acid, or citric acid, for example. In some aspects, a coagulation/neutralization medium can comprise water and about 4-25 wt % sulfuric acid and about 2-30 wt % sodium sulfate. In some aspects, a coagulation/neutralization medium comprises little (≤0.1 or 0.05 wt %) or no sulfate such as zinc sulfate.

A coagulated/neutralized form/shape following step (c) can optionally be washed; water or alcohol can be used for washing, for example. If desired, washing can be done until a neutral pH (e.g., pH 6-8, or ˜7) (of the wash) is achieved. Washing, or a post-washing step, can optionally further include bathing the form/shape in a 1-10 wt % (e.g., ˜5 wt %) plasticizer (e.g., glycerol or ethylene glycol) solution (e.g., water- or alcohol-based) for a suitable period of time (e.g., at least 2, 3, or 4 minutes). A form/shape herein is can be dried, if desired, such as by exposing it to a temperature of about 70-85° C. for a suitable period of time (e.g., 10-20 minutes). In some aspects, a coagulated form/shape following step (c) is not neutralized and/or washed.

In some aspects, coagulation and/or neutralization can be performed as described in U.S. Patent Appl. Publ. No. 2016/0177471, 2016/0333157, 2017/0283568, or 2015/0191550, or U.S. Pat. No. 7,000,000 or 11098334, which are incorporated herein by reference, or as disclosed in the below Examples (e.g., where each condition/parameter is conducted within 5%, 10%, or 15% of the relevant condition/parameter disclosed in the Examples).

In some aspects, step (c) can comprise air-blowing the caustic solution such that the alpha-glucan or alpha-glucan derivative thereof, and the additive if it was dissolved in the caustic solvent, is/are no longer dissolved in the caustic solvent. Such a process can be performed, for example, as described in U.S. Patent Appl. Publ. No. 2018/0282918, which is incorporated herein by reference. In some aspects, step (c) can comprise air drying the caustic solution such that the alpha-glucan or alpha-glucan derivative thereof, and the additive if it was dissolved in the caustic solvent, is/are no longer dissolved in the caustic solvent. Optionally, an air-dried form/shape following step (c) is not neutralized and/or washed.

In some aspects, a formed shape following step (c) herein is stretched and/or heated (e.g., ˜100-110° C.), or not stretched or heated.

In some aspects of a forming method as drawn to producing fibrids, steps (b) and (c) are generally performed concomitantly with each other in that a caustic solution herein is subjected to shearing forces (step [b] of shape-forming) while also being subjected to precipitation conditions (e.g., as described above for step [c], such as with an acid or an alcohol) that precipitate the alpha-glucan such that fibrids are formed comprising the alpha-glucan (or alpha-glucan derivative) and the additive. Such fibrids can optionally be characterized as “hybrid fibrids”. Such a process can be performed, for example, as described in U.S. Pat. No. 11,118,312, which is incorporated herein by reference, or as disclosed in the below Examples (e.g., where each condition/parameter is conducted within 5%, 10%, or 15% of the relevant condition/parameter disclosed in the Examples). It is contemplated that, in some aspects, the additive(s) becomes encased within the hybrid fibrids and/or embedded on the exterior surface of the hybrid fibrids (and/or some other mechanism of association) such that the additive(s) does not dissociate from (or mostly does not dissociate from) the hybrid fibrids under non-caustic aqueous conditions; this can even be the case in some aspects when the additive(s) is aqueous-soluble under non-caustic conditions (water-soluble). It is contemplated that this additive retention behavior likewise applies to other compositions herein such as fibers (e.g., filaments), films/coatings, or composites. Some aspects of producing hybrid fibrids (or other hybrid compositions herein) regard tuning/modulating/controlling the charge of fibrids/products. Such aspects typically comprise using a suitable amount of a charged additive herein (e.g., a charged polysaccharide or charged polysaccharide derivative) as part (c) of a caustic solution, along with alpha-glucan (uncharged/non-derivatized) herein as part (b) of a caustic solution, to produce fibrids or other compositions. This approach is advantaged over previous work in which the means to control product charge was through selecting a particularly charged alpha-glucan derivative as the only fibrid/product component (i.e., no additive); such typically entailed providing an alpha-glucan derivative having a particular degree of substitution with a charged moiety (e.g., charged organic group). Now, with the presently disclosed methodology, fibrids/products with a pre-selected charge can be produced, even when using a water-soluble charged additive (e.g., washing and/or other processing of products in non-caustic aqueous conditions does not remove any of, or a significant amount of, the water-soluble charged additive).

Some aspects herein are drawn to a method of producing a film/coating composition. Such a method can comprise, for example: (a) providing a preparation comprising at least (i) a caustic solvent herein, (ii) water-insoluble alpha-glucan herein, and (iii) an additive herein (e.g., hydrophobic additive), wherein the alpha-glucan is dissolved in the caustic solvent; (b) contacting the preparation with a substrate; and (c) removing the caustic solvent from the preparation of step (b) to produce a film/coating composition comprising the alpha-glucan and the additive. This method can optionally be characterized as a film or coat production method. The step of removing the caustic solvent can be performed as disclosed herein, if desired.

In some aspects of a film/coating production method, such as when the additive is a hydrophobic additive, the preparation is a dispersion. Such a dispersion can be an emulsion in aspects in which a liquid hydrophobic additive is used (i.e., the liquid is dispersed, but not dissolved, in the caustic solvent); examples of suitable liquid hydrophobic additives are disclosed herein.

A substrate on which a film or coating can be produced can be any as disclosed herein, for example. In some aspects, a substrate is, or comprises, a cellulose substrate, glass, leather, metal, non-cellulose-based polymer or fibrous material, masonry, drywall, plaster, wood, an architectural surface, or food (e.g., fruit or vegetable), for example. Examples of non-cellulose-based polymers herein include rubber (e.g., natural rubber) or other diene-based elastomer, polyamide, polyolefin, polylactic acid, polyethylene terephthalate (PET), poly(trimethylene terephthalate) (PTT), aramid, polyethylene sulfide (PES), polyphenylene sulfide (PPS), polyimide (PI), polyethylene imine (PEI), polyethylene naphthalate (PEN), polysulfone (PS), polyether ether ketone (PEEK), polyethylene, polypropylene, poly(cyclic olefins), poly(cyclohexylene dimethylene terephthalate), and poly(trimethylene furandicarboxylate) (PTF). In some aspects, a cellulose substrate comprises about, or at least about, 80%, 82.5%, 85%, 87.5%, 90%, 91%, 92% 93%, 94%, 95%, 96%, 97%, 98%, 99%, 99.5%, or 100% by weight cellulose (typically in the form of cellulose fiber). Other components of a cellulose substrate can optionally include hemicellulose and/or lignin. A cellulose substrate is typically porous. A substrate in some aspects can be a woven or non-woven material (e.g. woven or non-woven fabric).

A film or coating in some aspects can be a food casing. A food casing can be for a meat-based food product (e.g., a meat product such as a ground meat product, sausage, or processed meat product) or plant-based food product (e.g., a meat substitute, a food containing tofu, or a food containing bean), for example.

A coating in some aspects can be a seed coating or fertilizer coating. Such a coating can have any of the features (e.g., thickness, insoluble alpha-glucan content, additive) of a film/coating herein, for example. As with any solid composition/product of the present disclosure, a seed coating or fertilizer coating in some alternative aspects does not comprise an additive herein, where such additive would have been present in a dope solution used to produce the seed coating or fertilizer coating. A seed coating herein can be adapted accordingly for manufacture and/or use as disclosed in U.S. Patent Appl. Publ. No. 2018/0325104, 2012/0220454, or 2012/0065060, for example, which are each incorporated herein by reference. A fertilizer coating herein can be adapted accordingly for manufacture and/or use as disclosed in U.S. Patent Appl. Publ. No. 2016/0229763, 2003/0033843, or 2009/0229330, for example, which are each incorporated herein by reference.

In some aspects of a film or coat production method, or in aspects of producing any other hybrid solid composition herein (e.g., fiber, extrusion, fibrid, powder, or composite), the film or coating (or other hybrid solid composition) can be heated to a temperature of at least about 45° C. (or to a temperature that melts the additive). An additive in such aspects can be hydrophobic, for example, and/or be a solid at 20-25° C. In some aspects, heating can be to about, or at least about, 45, 46, 48, 50, 52, 54, 56, 58, 60, 62, 64, 66, 68, 70, 75, 80, 85, 90, 95, 100, 45-70, 45-65, 50-70, or 50-65° C., or to about, or at least about, the melting point temperature of an otherwise solid hydrophobic additive herein. Typically, a heating temperature can be maintained for a suitable length of time (e.g., ≥15, 30, 45, 60, 120, 240, or 360 seconds) to melt the additive in the film/coating or other hybrid solid composition (i.e., melting occurs in the composition in situ). Such heating and in situ melting of an additive can, in some aspects, serve to heat-seal a film/coating or other hybrid solid composition herein.

Some aspects of producing a solid composition can further comprise providing a powder (or other particulate form such as particles). For example, a solid composition, typically after it has been dried, can be ground up, or otherwise comminuted, into a powder.

Some aspects of the present disclosure regard a composition/product comprising a solid composition that comprises at least alpha-glucan and/or a derivative thereof, wherein (i) the alpha-glucan and/or derivative thereof is crosslinked, and/or (ii) the composition further comprises an additive (e.g., water-insoluble or water-soluble) that is not chemically linked to the alpha-glucan or derivative thereof, wherein at least about 50% of the glycosidic linkages of the alpha-glucan are alpha-1,3 glycosidic linkages, and the weight-average degree of polymerization of the alpha-glucan is at least 15. Examples of a solid composition (hybrid solid composition) herein include a fiber (e.g., filament), fibrid (hybrid fibrid), extrusion, composite, powder (dry powder), or film/coating. A solid composition can be produced as disclosed herein, for instance, and/or have any features herein of one or more components used to produce a solid composition. A solid composition herein typically is not produced in a manner that does not comprise using a caustic solution herein; for example, a solid composition herein typically is not produced by a method comprising dispersing insoluble alpha-glucan, or an insoluble derivative thereof, in a non-caustic aqueous medium followed by shape forming and removal of water (drying) (without having processed the alpha-glucan or derivative thereof in a caustic solution).

A solid composition/product as presently disclosed can comprise, for example, at least about 0.5 wt % of at least one additive herein and up to about 99.5 wt % of at least one water-insoluble alpha-glucan (or water-insoluble derivative thereof, which, if present, is different from the additive [s]). In some aspects, a solid composition/product comprises (i) about, or at least about, 0.01, 0.025, 0.05, 0.1, 0.25, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, 0.01-50, 0.01-40, 0.01-30, 0.01-20, 0.01-10, 0.01-5, 0.1-50, 0.1-40, 0.1-30, 0.1-20, 0.1-10, 0.1-5, 0.5-50, 0.5-40, 0.5-30, 0.5-20, 0.5-10, 0.5-5, 1-50, 1-40, 1-30, 1-20, 1-10, 1-5, 2.5-50, 2.5-40, 02.5-30, 2.5-20, 2.5-10, 5-50, 5-40, 5-30, 5-20, or 5-10 wt % of at least one additive, and (ii) about, or up to about, 99.99, 99.975, 99.95, 99.9, 99.75, 99.5, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, 0.5, 50-99.99, 60-99.99, 70-99.99, 80-99.99, 90-99.99, 95-99.99, 50-99.9, 60-99.9, 70-99.9, 80-99.9, 90-99.9, 95-99.9, 50-99.5, 60-99.5, 70-99.5, 80-99.5, 90-99.5, 95-99.5, 50-99, 60-99, 70-99, 80-99, 90-99, 95-99, 50-97.5, 60-97.5, 70-97.5, 80-97.5, 90-97.5, 95-97.5, 50-95, 60-95, 70-95, 80-95, or 90-95, wt % of at least one water-insoluble alpha-glucan (or water-insoluble derivative thereof).

A solid composition/product is biodegradable in some aspects. Such biodegradability can be, for example, as determined by the Carbon Dioxide Evolution Test Method (OECD Guideline 301B, incorporated herein by reference), to be about, at least about, or at most about, 5%, 10%, 15%, 20%, 25%, 30%, 35%, 40%, 45%, 50%, 55%, 60%, 65%, 70%, 75%, 80%, 85%, 90%, 5-60%, 5-80%, 5-90%, 40-70%, 50-70%, 60-70%, 40-75%, 50-75%, 60-75%, 70-75%, 40-80%, 50-80%, 60-80%, 70-80%, 40-85%, 50-85%, 60-85%, 70-85%, 40-90%, 50-90%, 60-90%, or 70-90%, or any value between 5% and 90%, after 15, 30, 45, 60, 75, or 90 days of testing.

A solid composition/product herein typically is non-porous (e.g., pores cannot be detected on a micrometer or nanometer scale, either on the product surface or by cross-sectional analysis). However, in some aspects, a solid composition/product can be porous (e.g., contain discontinuous pores and/or continuous pores). A solid porous composition/product can be a foam, aerogel, or sponge, for example, and/or be nanoporous (e.g., mesoporous), microporous, or macroporous. Pores can be provided by, for example, introducing a gas (e.g., air, nitrogen, carbon dioxide) to a caustic solution during forming step (b) and then performing step (c) such as by coagulation/neutralization. Yet, in some aspects, pores can be provided by, for example, introducing a gas (e.g., carbon dioxide) to a caustic solution when performing a step (c) that comprises neutralization; in this sense, forming step (b) can extend into step (c) insofar as pore formation can optionally be considered part of the shape forming process. Gas formation during a neutralization of a step (c) herein can be accomplished by including an additive that, when in a milieu being neutralized (e.g., during dope neutralization) such as with an acid, reacts to form products including a gas (e.g., carbon dioxide). An example of such an additive is a carbonate salt herein (e.g., calcium carbonate); such an additive can be present at about 0.1-10 wt % (e.g., any wt % in this range as disclosed herein) in a dope solution, for example. Pores, such as those of a sponge, can be provided in some aspects by including one more water-soluble salts in a caustic solution (provided in step [a]) and, following step (c), dissolving the salt out of the solid composition with water or an aqueous solution.

A composition/product as presently disclosed comprising at least one solid composition herein can be an aqueous composition/product (e.g., a dispersion such as colloidal dispersion, a mixture) or a dry composition/product, for example. In some aspects, a composition/product herein can comprise about, at least about, or less than about, 0.001, 0.0025, 0.005, 0.0075, 0.01, 0.025, 0.05, 0.1, 0.2, 0.25, 0.3, 0.4, 0.5, 0.6, 0.7, 0.75, 0.8, 0.9, 1.0, 1.2, 1.25, 1.4, 1.5, 1.6, 1.75, 1.8, 2.0, 2.25, 2.5, 3.0, 3.5, 4.0, 4.5, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 99.5 wt % or w/v % of a solid composition herein. A composition/product can comprise a range between any two of these wt % or w/v % values, for example. Any of these concentration values can be expressed in terms of its respective parts-per-million (ppm) value, if desired. The liquid component (liquid medium, aqueous medium) of an aqueous composition/product can be a water or other non-caustic aqueous medium, for instance. The solvent of a non-caustic aqueous medium typically is water, or can comprise about, or at least about, 10, 20, 30, 40, 50, 60, 70, 80, 90, 95, 98, or 99 wt % water, for example.

The temperature of a composition herein such as an aqueous medium in which a solid composition can be comprised can be about, at least about, or up to about, 0, 1, 5, 10, 15, 20, 25, 30, 35, 37, 40, 42, 45, 50, 55, 60, 65, 70, 75, 80, 85, 90, 95, 100, 105, 110, 115, 120, 125, 130, 10-30, 10-25, 15-30, 15-25, 20-40, 20-35, 20-30, 20-25, 25-30, 30-50, 30-45, 30-40, 30-35, 35-40, 35-50, 40-45, 50-60, 5-50, 40-130, 40-125, 40-120, 70-130, 70-125, 70-120, 80-130, 80-125, 80-120, 60-100, 60-90, 70-100, 70-90, 75-100, 75-90, 75-85, or 1-130° C., for example.

The pH of an aqueous medium in which a solid composition herein can be comprised can be about 4.0, 4.5, 5.0, 5.5, 6.0, 6.5, 7.0, 7.5, 8.0, 8.5, 9.0, 9.5, 10.0, 10.5, 4.0-10.0, 4.0-9.0, 4.0-8.0, 5.0-10.0, 5.0-9.0, 5.0-8.0, 6.0-10.0, 6.0-9.0, or 6.0-8.0, for example.

The amount of time in which a solid composition herein can have been in an aqueous medium can be about, or at least about, 0.5, 1, 5, 10, 30, 60, 90, 120, 150, 180, 210, 240, 300, 360, 420, 480, 540, 600, 660, or 720 minutes, 0.5, 1, 2, 4, 6, 8, 10, 20, 30, 60, 90, 120, 150, 180, 210, 240, 270, 300, 330, or 360 days, or 1, 2, or 3 years, for example.

An aqueous composition herein can have a viscosity of about, at least about, or less than about, 1, 5, 10, 100, 200, 300, 400, 500, 600, 700, 1000, 2000, 3000, 4000, 5000, 6000, 7000, 8000, 9000, 10000, 15000, 1-300, 10-300, 25-300, 50-300, 1-250, 10-250, 25-250, 50-250, 1-200, 10-200, 25-200, 50-200, 1-150, 10-150, 25-150, 50-150, 1-100, 10-100, 25-100, or 50-100 centipoise (cps), for example. Viscosity can be as measured with an aqueous composition herein at any temperature between about 3° C. to about 80° C., for example (e.g., 4-30° C., 15-30° C., 15-25° C.). Viscosity typically is as measured at atmospheric pressure (about 760 torr) or a pressure that is +10% thereof. Viscosity can be measured using a viscometer or rheometer, for example, and can optionally be as measured at a shear rate (rotational shear rate) of about 0.1, 0.5, 1.0, 5, 10, 50, 100, 500, 1000, 0.1-500, 0.1-100, 1.0-500, 1.0-1000, or 1.0-100 s⁻¹ (1/s), for example.

A solid composition herein can have a positive surface charge or negative surface charge in some aspects; there is no (or very little, such as less than ±0.02 or ±0.015 mV) surface charge in some aspects (i.e., neutral charge). “±” herein refers to plus or minus. Typically, a cationic or anionic surface charge is due to the charge (or average charge) of one or more charged additives comprised in the solid composition. Surface charge can be measured in terms of zeta potential with a solid composition in water (e.g., as a dispersion), and/or with solid compositions in a particulate form (e.g., fibrids, powder), for example. The zeta potential of a solid composition in some aspects can be about, or over about, ±5 mV, ±10 mV, ±15 mV, ±20 mV, ±25 mV, ±30 mV, ±35 mV, ±40 mV, ±45 mV, or ±50 mV. Simply for illustration purposes, it should be understood that a zeta potential “over” ±5 mV, for example, excludes zeta potentials ranging from −5 mV to +5 mV. In some aspects, the zeta potential is about +20 to +40 mV, +25 to +40 mV, +30 to +40 mV, +20 to +45 mV, +25 to +45 mV, +30 to +45 mV, +20 to +50 mV, +25 to +50 mV, or +30 to +50 mV. The foregoing zeta potential values can in some aspects be associated with aqueous compositions having a pH of about 6.5-7.5, 6-8, 5-9, or 4-9.

In some aspects herein in which a solid composition is comprised in a non-caustic aqueous medium (e.g., water), and the additive of the solid composition is aqueous-soluble under non-caustic conditions (water-soluble). About, or at least about, 80, 85, 90, 95, 96, 97, 98, 99, 100, 80-100, 80-99, 80-97, 90-100, 90-99, 90-97, 95-100, 95-99, or 95-97 wt % of the aqueous-soluble additive can be comprised in the solid composition (remain comprised in the solid composition and not be dissolved into the aqueous medium), for example. This aspect is despite the presence of water, which could otherwise dissolve soluble additive. Thus, in some aspects, the aqueous medium can comprise about, or less than about, 20, 15, 10, 5, 4, 3, 2, 1, 0, 0-20, 1-20, 3-20, 0-10, 1-10, 3-10, 0-5, 1-5, or 3-5 wt % of the aqueous-soluble additive that was initially/originally completely comprised in the solid composition (before placing the solid composition into the aqueous medium). Thus, some aspects of the present disclosure regard a method of handling a solid composition herein (e.g., a hybrid solid composition such as a fibrid, fiber, extrusion, composite, powder, or film/coating herein). Such a method can comprise: (a) providing a solid composition herein, and (b) contacting the solid composition with a non-caustic aqueous liquid (or subjecting/treating/washing under non-caustic aqueous conditions), wherein the contacting does not remove any of the additive from the solid composition, or the contacting removes less than 20 wt % of the additive from the solid composition). A non-caustic aqueous liquid can be any as disclosed herein (e.g., water), have any relevant features (e.g., temperature, non-caustic pH), and/or be contacted for a suitable amount of time (e.g., as disclosed herein). The volume of liquid used in a handling method herein can be about, or at least about, 0.25, 0.5, 1.0, 2, 3, 4, 5, 6, 7, 9, or 10 times the volume of the solid composition, for example. Contacting can optionally be performed two, three, four, or more times (e.g., iteratively, such as in washing), and/or can comprise some form of agitation (e.g., mixing, slurrying). A handling method of the disclosure can optionally further comprise separating (e.g., via filtration or decanting) all of, or most of (e.g., at least about 50, 60, 70, 80, 90, 95, 96, 97, 98, 99, or 99.5 wt %), the non-caustic aqueous liquid from the solid composition, wherein the non-caustic aqueous liquid (as it exists following separation) does not comprise any of the additive (e.g., additive not dissolved in the liquid), or comprises about, or less than about, 20, 15, 10, 5, 4, 3, 2, 1, 0, 0-20, 1-20, 3-20, 0-10, 1-10, 3-10, 0-5, 1-5, or 3-5 wt % of the additive that was in the solid composition prior to the contacting step. A separating step can be conducted after each contacting step, for example. The foregoing concentration values can characterize liquid used in any of the contacting steps (e.g., the first contacting step, and if performed, a second or additional contacting step). One or more additives in some aspects of a handling method can be aqueous-soluble under non-caustic conditions (e.g., any such additive disclosed herein, such as a charged additive). A charged additive can be a charged polysaccharide or charged polysaccharide derivative herein, for example.

A solid composition herein, when not comprised in an aqueous medium, typically can be considered as non-aqueous (e.g., a dry composition). Examples of such embodiments include powders, granules, microcapsules, flakes, or any other form of particulate matter. Other examples include larger compositions such as pellets, bars, kernels, beads, tablets, sticks, or other agglomerates. A non-aqueous or dry composition typically has about, or no more than about, 5, 4, 3, 2, 1.5, 1.0, 0.5, 0.25, 0.10, 0.05, or 0.01 wt % water comprised therein.

A solid composition can be a fiber (e.g., filament) in some aspects. A product/composition comprising a fiber can be a non-woven product, woven product (textile), or any other fiber-containing product. A fabric herein can be non-woven or woven.

Materials/articles/products containing one or more fabrics herein include, for example, clothing (e.g., exercise/fitness/sport clothing), curtains, shower curtains, drapes, upholstery, carpeting, bed linens, bath linens, towels, tablecloths, sleeping bags, tents, car interiors, laundry containers, etc.

A non-woven product (e.g., non-woven fabric, non-woven web) herein can be air-laid, dry-laid, wet-laid, carded, electrospun, spun-lace, or spun-bond (directly spun, direct spinning), for example. In some aspects, a non-woven product can be an abrasive or scouring sheet, agricultural covering, agricultural seed strip, apparel lining, automobile headliner or upholstery, bib, cheese wrap, civil engineering fabric, coffee filter, cosmetic remover or applicator, detergent pouch/sachet, fabric softener sheet, envelope, face mask, filter, garment bag, heat or electricity conductive fabric, household care wipe (e.g., for floor care, hard surface cleaning, pet care, etc.), house wrap, hygiene product (e.g., sanitary pad/napkin, underpad), insulation, label, laundry aid, medical care or personal injury care product (e.g., bandage, cast padding or cover, dressing, pack, sterile overwrap, sterile packaging, surgical drape, surgical gown, swab), mop, napkin or paper towel, paper, tissue paper, personal wipe or baby wipe, reusable bag, roofing undercovering, table linen, tag, tea or coffee bag, upholstery, vacuum cleaning bag, or wallcovering. Examples of non-woven products herein and/or methods of producing non-woven products can be as disclosed in U.S. Pat. Appl. Publ. Nos. 2020/0370216, 2018/0282918, 2017/0167063, 2018/0320291, 2018/0340270, 2016/0053406, or 2010/0291213, which are each incorporated herein by reference.

A fiber-containing product herein can be a paper/packaging composition or cellulose fiber-containing composition. Examples of such compositions include paper (e.g., writing paper, office paper, copying paper, crafting paper), cardboard, paperboard, corrugated board, tissue paper, napkin/paper towel, wipe, or non-woven fabric. Formulations and/or components (in addition to those herein) of a paper/packaging composition or cellulose fiber-containing composition herein, and well as forms of these compositions, can be as described in, for example, U.S. Patent Appl. Publ. Nos. 2018/0119357, 2019/0330802, 2020/0062929, 2020/0308371, or 2020/0370216, which are each incorporated herein by reference.

In some aspects, a non-woven product (fabric) or woven product (fabric) has a weight that is about, or at most about, 25, 26, 27, 28, 29, 30, 31, 32, 33, 34, 35, 36, 37, 38, 39, 40, 45, 50, 55, 60, 65, 70, 80, 90, 100, 25-50, 25-45, 25-40, 25-35, 25-33, 25-32, 28-50, 28-45, 28-40, 28-35, 28-33, 28-32, 28-31, 29-32, 29-31, 50-70, 50-65, 55-70, or 55-65 gsm (grams per square meter [of fabric]).

A solid composition can be an extruded product in some aspects. Examples of extruded products include fiber (filaments), tube-shaped products (e.g., tubes, pipes, straws such as drinking straws), bags, sheets, films, gaskets, and rods.

In some aspects, a composition herein (e.g., film, coating, fiber [e.g., filament], fibrid, extrusion, composite) has a tensile strength (ultimate tensile strength) of about, or at least about, 35, 40, 45, 50, 55, 60, 65, 35-65, 40-65, 45-65, 35-60, 40-60, 45-60, 35-55, 40-55, or 45-55 MPa (megapascals). Tensile strength can be as measured according to the below Examples (e.g., where each condition/parameter is conducted within 5%, 10%, or 15% of the relevant condition/parameter disclosed in the Examples) or as disclosed in DIN EN ISO 527-3, for instance, which is incorporated herein by reference. In some aspects, the tensile strength of a composition herein comprising one or more additives is about, or at least about, 10%, 20%, 30%, 40%, 50%, 60%, 70%, 80%, 90%, 100%, 110%, 120%, 130%, 140%, or 150% higher than the tensile strength of otherwise the same composition, but that lacks the one or more additives.

In some aspects, a composition herein (e.g., film, coating, fiber [e.g., filament], fibrid, extrusion, composite) has a percent elongation to break (percent elongation) of about, or at least about, 40%, 45%, 50%, 55%, 60%, 65%, 40-65%, 45-65%, 50-65%, 40-60%, 45-60%, or 50-60%. Percent elongation can be as measured according to the below Examples (e.g., where each condition/parameter is conducted within 5%, 10%, or 15% of the relevant condition/parameter disclosed in the Examples) or as disclosed in DIN EN ISO 527-3, for instance, which is incorporated herein by reference. In some aspects, the percent elongation of a composition herein comprising one or more additives is about, or at least about, 10%, 20%, 30%, 40%, 50%, 60%, 70%, or 80% higher than the percent elongation of otherwise the same composition, but that lacks the one or more additives.

A film or coating/layer of a composition herein can have a thickness of about, at least about, or less than about, 1, 2.5, 5, 10, 15, 20, 25, 30, 35, 40, 45, 50, 55, 60, 65, 70, 85, 90, 95, 100, 105, 110, 120, 130, 140, 150, 160, 170, 180, 190, 200, 10-30, 10-25, 10-20, 15-30, 15-25, 15-20, 30-70, 40-60, 70-130, 70-120, 70-110, 70-100, 80-130, 80-120, 80-110, 80-100, 90-130, 90-120, 90-110, or 90-100 microns (micrometers, μm), for instance. In some aspects, such thickness is uniform, which can be characterized by having a contiguous area that (i) is at least 20%, 30%, 40%, or 50% of the total coating area, and (ii) has a standard deviation of thickness of less than about 0.5, 1, 1.5, or 2 microns.

In some aspects, a substrate is coated with one layer (a single layer) of a coating composition herein. However, in some aspects, there can be multiple (e.g., two, three, or more) coats of a coating composition, and such additional coat(s) can be the same as, or different from, the first coat. A coating herein can be one or more of the coatings contained in a laminate material, for example.

A film/coating herein can exhibit various degrees of transparency as desired. For example, a film/coating can be highly transparent (e.g., high light transmission, and/or low haze). Optical transparency as used herein can, for example, refer to a film/coating allowing at least about 10-99% light transmission, or at least about 50%, 60%, 70%, 80%, 90%, 95%, 96%, 97%, 98%, or 99% light transmission, and/or less than 30%, 25%, 20%, 15%, 10%, 5%, 2.5%, 2%, or 1% haze. High optical transparency can optionally refer to a film/coating having at least about 90% light transmittance and/or a haziness of less than 10%. Light transmittance of a film/coating herein can be measured following test ASTM D1746 (2009, Standard Test Method for Transparency of Plastic Sheeting, ASTM International, West Conshohocken, PA), for example, which is incorporated herein by reference. Haze of a film/coating herein can be measured following test ASTM D1003-13 (2013, Standard Test Method for Haze and Luminous Transmittance of Transparent Plastics, ASTM International, West Conshohocken, PA), for example, which is incorporated herein by reference.

A film/coating herein can optionally further comprise a plasticizer such as glycerol, propylene glycol, ethylene glycol, and/or polyethylene glycol. In some aspects, other film/coating components (in addition to at least insoluble alpha-glucan and additive) can be as disclosed in U.S. Patent. Appl. Publ. No. 2011/0151224, 2015/0191550, or 20170208823, or U.S. Pat. No. 9,688,035 or 3345200, all of which are incorporated herein by reference.

A film or other sheet-like product of the present disclosure can be in the form of a membrane, for example. A membrane in some aspects can be used for a separation or purification process, such as dialysis, biological component separation/purification, or reverse osmosis (e.g., a dialysis membrane, protein separation membrane, reverse osmosis membrane). As with any solid composition/product of the present disclosure, a membrane in some alternative aspects does not comprise an additive herein, where such additive would have been present in a dope solution used to produce the membrane.

A film, sheet, or sheet-like product of the present disclosure can be for applying to (e.g., laying onto, pressing onto) skin (e.g., human skin). Examples of skin suitable for this purpose are facial skin (e.g., entire face, nose, lips, eye lids, eye brows, cheeks, chin, forehead) (a face mask is an example of such a product), ear skin, and body skin (e.g., arms, legs, torso, hands, feet, cuticles, neck, scalp [typically if shaven]). Such a product can have any of the features (e.g., thickness, insoluble alpha-glucan content, water content, transparency) of a film/coating herein, for example. As with any solid composition/product of the present disclosure, a film product for skin application in some alternative aspects does not comprise an additive herein, where such additive would have been present in a dope solution used to produce the film product. Regardless of whether a film product for skin application comprises a dope-borne additive, a film product can be treated/modified (e.g., impregnated with) after its production to comprise one or more additives/agents, typically where such one or more additives/agents provide a therapeutic benefit, cosmetic benefit, or any other benefit to the skin being targeted by the film product. Examples of such one or more additives/agents (skin-treating agents) include enzymes, vitamins (e.g., vitamin C), minerals, drugs, keratolytic agents (e.g., salicylic acid, azelaic acid), anti-acne agents (e.g., salicylic acid, benzoyl peroxide), skin lightening agents, anti-wrinkle/lines agents, antioxidants, moisturizing agents, oil reduction (anti-sebum) agents, hyaluronic acid, glycolic acid, ceramide, charcoal, clay, activated carbon, and curcumin (and/or any suitable additive disclosed herein). One or more of these or other skin-treating agents can optionally have been a dope additive, as appropriate (in addition to, or instead of, an additive added to the film product after film formation). A film product for skin application herein can be adapted accordingly for manufacture and/or use as disclosed in U.S. Pat. Nos. 8,425,477, 5,538,732, or 10448727, for example, which are each incorporated herein by reference.

In some aspects, one side of a film/coating is hydrophilic, and the other side of the film/coating is hydrophobic (e.g., characteristics of a film/coating having at least one additive herein that is an oil). Such a film/coating can optionally be characterized to have “surface polarity” in terms of water attraction/dis-attraction. The hydrophobicity or hydrophilicity of a film or coating surface can be determined, for example, by measuring the contact angle of water that is in direct contact with the surface. For example, a droplet of water in contact with a hydrophobic surface can exhibit a contact angle that is about, or at least about, 85°, 90°, 95°, 100°, 105°, 85°-105°, 90°-105°, 95°-105°, 85°-100°, 90°-100°, 95°-100°, 85°-95°, or 90°-95°, and/or a droplet of water in contact with a hydrophilic surface can exhibit a contact angle that is about, or less than about, 80°, 75°, 70°, 65°, 60°, 55°, 50°, 45°, 45°-80°, 45°-75°, or 45°-70°. A film/coating can have one side that is more (e.g., >10%, 20%, 30%, or 40% more) hydrophilic (or hydrophobic) than the other side, for instance.

Some aspects are drawn to a coating on a substrate herein, and the side of the coating that is opposite the side of the coating contacting the substrate is hydrophobic (i.e., the exterior- or outward-facing side of the coating is hydrophobic), while the side in contact with the substrate (i.e., the interior-facing side of the coating) is hydrophilic. In such aspects, a coating typically better adheres to (e.g., at least 10%, 20%, 30%, 40%, or 50% better) a substrate having a hydrophilic surface, as compared to a neutral surface or hydrophobic surface, and/or as compared to a coating herein that does not have surface polarity. In such aspects, a coating typically better repels water (e.g., at least 10%, 20%, 30%, 40%, or 50% better) as compared to a coating herein that does not have surface polarity.

A substrate that can be coated with a composition herein can comprise, or be, a cellulose substrate, glass, leather, metal, non-cellulose-based polymer or fibrous material, masonry, drywall, plaster, wood, an architectural surface, or food (e.g., fruit or vegetable), for example. Examples of non-cellulose-based polymers herein include rubber (e.g., natural rubber) or other diene-based elastomer, polyamide, polyolefin, polylactic acid, polyethylene terephthalate (PET), poly(trimethylene terephthalate) (PTT), aramid, polyethylene sulfide (PES), polyphenylene sulfide (PPS), polyimide (PI), polyethylene imine (PEI), polyethylene naphthalate (PEN), polysulfone (PS), polyether ether ketone (PEEK), polyethylene, polypropylene, poly(cyclic olefins), poly(cyclohexylene dimethylene terephthalate), and poly(trimethylene furandicarboxylate) (PTF). In some aspects, a cellulose substrate comprises about, or at least about, 80%, 82.5%, 85%, 87.5%, 90%, 91%, 92% 93%, 94%, 95%, 96%, 97%, 98%, 99%, 99.5%, or 100% by weight cellulose (typically in the form of cellulose fiber). Other components of a cellulose substrate can optionally include hemicellulose and/or lignin. A cellulose substrate is typically porous. A substrate in some aspects can be a woven or non-woven material (e.g. woven or non-woven fabric).

A cellulose substrate in some aspects can be a paper product, woven product, or non-woven product. Examples of a paper product include paper, cardboard, paperboard, corrugated board, boxboard, and molded or compressed paper fiber. Another example of a paper product is a paper straw (drinking straw). The foregoing are also examples of a composition or product herein that comprise a cellulose substrate. A composition or product herein comprising a cellulose substrate can be a packaging or container in some aspects, and typically comprises one or more of the foregoing paper products. Examples of packaging and/or containers herein include boxes (e.g., paperboard boxes, cardboard boxes, corrugated boxes, rigid boxes), chipboard, cartons (e.g., beverage carton, folding carton), bags, cups, plates, wrap/wrappers, tubes/tubing, cones, french fry holder or similar holder, tray, tissue paper, parchment paper and kraft paper. While a paper product can have one side that is covered with foil (e.g., foil-sealed), such as aluminum foil, or plastic, a paper product herein typically does not comprise such a covering. A packaging or container can be closed (e.g., sealed shut) or open (e.g., unsealed).

A coating composition as applied to a substrate herein can cover all of, or at least about, 40%, 45%, 50%, 55%, 60%, 65%, 70%, 75%, 80%, 85%, 90%, 91%, 92%, 93%, 94%, 95%, 96%, 97%, 98%, 99%, or 99.5% of the area of one or both sides of the substrate, for example. With regard to a composition or product that has inside and outside surfaces (e.g., box, carton, french fry holder), a coating can be on the inside surface, outside surface, or both surfaces.

In some aspects, a composition herein such as a packaging or container holds a product, optionally wherein the coating (typically on the inner/inside surface of the packaging/container) is in contact with the product. Such a product can be an ingestible product (e.g., food product), pharmaceutical product, personal care product, home care product, or industrial product, for example. Examples of these types of products are described in U.S. Patent Appl. Publ. Nos. 2018/0022834, 2018/0237816, 2018/0230241, 20180079832, 2016/0311935, 2016/0304629, 2015/0232785, 2015/0368594, 2015/0368595, 2016/0122445, 2019/0202942, or 2019/0309096, or International Patent Appl. Publ. No. WO2016/133734, which are all incorporated herein by reference. In some aspects, a packaging or container holds, and its coating optionally is in contact with, at least one component/ingredient of an ingestible product (e.g., food product), pharmaceutical product, personal care product, home care product, or industrial product, as disclosed in any of the foregoing publications and/or as presently disclosed.

In some aspects, a product being held in the packaging/container comprises oil, grease, and/or water on its surface and the product is in contact with the inner surface of the packaging/container (optionally, the product is in contact with a layer of the coating composition if the layer happens to be located on the inner surface of the packaging/container). Typically, at least a portion of (e.g., at least about 80, 85, 90, 91, 92, 93, 94, 95, 96, 97, 98, 99, or 99.5 wt %), or all of, the oil, grease, and/or water of the product is contained inside the packaging or container. In other words, most or all of the oil, grease, and/or water is not able to transit through the packaging or container to be on the outer/exterior surface of the packaging or container.

A composition herein can be at a temperature of, and/or in an environment/system with a temperature of, about 1-50, 1-45, 1-40, 1-35, 1-30, 1-25, 1-20, 5-30, 10-30, 15-30, 20-30, 5-25, 10-25, 15-25, or 20-25° C., for example (or any other temperature disclosed herein). A composition herein can be in an environment with a relative humidity level of about, or at least about, 10%, 20%, 30%, 40%, 50%, 60%, 70%, 80%, 90%, 100%, 20%-100%, 30%-100%, 40%-100%, 50%-100%, 60%-100%, 70%-100%, 80%-100%, 20%-90%, 30%-90%, 40%-90%, 50%-90%, 60%-90%, 70%-90%, or 80%-90%, for example. An illustrative example of a composition that can be in any of the foregoing temperature and/or relative humidity conditions is a package or container herein that is holding a product.

Typically, a product herein (e.g., pharmaceutical product, personal care product, home care product, industrial product, or ingestible product such as a food product), if stored in a closed or sealed package/container herein (e.g., for 1, 2, 3, 6, 9, 12, 18, 24, 30, or 36 months), can be protected from exposure to water, water vapor, and/or oxygen originating from outside of the package/container. Such storage prevents a product from going stale and/or rancid, or any other form of spoilage or loss of freshness or function, for example.

A composition as presently disclosed—e.g., a hybrid solid composition such as a fiber [e.g., filament], fibrids, extrusion, composite, powder, or film/coating herein—can be in the form of, or comprised in, a household care product, personal care product, industrial product, ingestible product (e.g., food product), medical product, or pharmaceutical product, for example, such as described in any of U.S. Patent Appl. Publ. Nos. 2018/0022834, 2018/0237816, 2018/0230241, 20180079832, 2016/0311935, 2016/0304629, 2015/0232785, 2015/0368594, 2015/0368595, 2016/0122445, 2019/0202942, 2019/0309096, or 2021/0130504, or International Patent Appl. Publ. No. WO2016/133734, which are all incorporated herein by reference. In some aspects, a composition can comprise at least one component/ingredient of a household care product, personal care product, industrial product, pharmaceutical product, medical product, or ingestible product (e.g., food product) as disclosed in any of the foregoing publications and/or as presently disclosed.

A composition in some aspects is believed to be useful for providing one or more of the following physical properties to a personal care product, pharmaceutical product, household product, industrial product, or ingestible product (e.g., food product): thickening, freeze/thaw stability, lubricity, moisture retention and release, texture, consistency, shape retention, emulsification, binding, suspension, dispersion, gelation, reduced mineral hardness, for example.

In some alternative aspects, a solid composition/product can be any of those disclosed herein, but without further comprising an additive, where such additive would have been present in a dope solution used to produce the solid composition/product (i.e., such a solid composition/product is not “hybrid” as disclosed elsewhere herein).

Non-limiting examples of compositions and methods disclosed herein include:
1. A solution (e.g., caustic solution/dope solution) comprising at least (a) a caustic solvent, (b) alpha-glucan and/or a derivative thereof (or alpha-glucan that was crosslinked before being entered to the caustic solvent) (typically wherein the alpha-glucan or a derivative thereof [or pre-crosslinked alpha-glucan] is/are aqueous-insoluble under non-caustic conditions), and (c) an additive, wherein the additive is (i) a crosslinking agent, and/or (ii) optionally an additive that does not chemically react with the alpha-glucan or derivative thereof (optionally no additive if alpha-glucan is used that was crosslinked before being entered to the caustic solvent), wherein at least about 50% of the glycosidic linkages of the alpha-glucan are alpha-1,3 glycosidic linkages, and the weight-average degree of polymerization of the alpha-glucan is at least 15, wherein the alpha-glucan or derivative thereof is dissolved in the caustic solvent, and the additive is dissolved or not dissolved in the caustic solvent.
2. The solution of embodiment 1, wherein at least about 90% of the glycosidic linkages of the alpha-glucan are alpha-1,3 glycosidic linkages.
3. The solution of embodiment 1 or 2, wherein the solution comprises the alpha-glucan (i.e., the non-derivatized alpha-glucan).
4. The solution of embodiment 1, 2, or 3, wherein the solution comprises about 5 wt % to about 20 wt % (e.g., 7.5 wt % to 15 wt %) of the alpha-glucan and/or derivative thereof. 5. The solution of embodiment 1, 2, 3, or 4, wherein the additive is the crosslinking agent.
6. The solution of embodiment 1, 2, 3, or 4, wherein the additive is the additive that does not react with the alpha-glucan or derivative thereof.
7. The solution of embodiment 1, 2, 3, 4, 5, or 6, wherein the additive is aqueous-soluble under non-caustic conditions (e.g., water-soluble).
8. The solution of embodiment 1, 2, 3, 4, 5, 6, or 7, wherein the additive is a polysaccharide derivative.
9. The solution of embodiment 1, 2, 3, 4, 5, 6, 7, or 8, wherein the caustic solvent is an aqueous alkali metal hydroxide.
10. The solution of embodiment 1, 2, 3, 4, 5, 6, 7, 8, or 9, wherein the solution is in the form of a dope filament.
11. A method of producing a solution according to any of embodiments 1, 2, 3, 4, 5, 6, 7, 8, 9, or 10, the method comprising: mixing at least the alpha-glucan and/or derivative thereof, and the additive, with a caustic solvent, wherein the alpha-glucan and/or derivative thereof dissolves in the caustic solvent.
12. A method of producing a solid composition, the method comprising: (a) providing a solution according to any of embodiments 1, 2, 3, 4, 5, 6, 7, 8, 9, or 10, or a solution as produced by the method of embodiment 11, (b) putting the solution into a desired form/shape, and (c) removing the caustic solvent from the solution of step (b) to produce a solid composition comprising the alpha-glucan or derivative thereof, and the additive.
13. The method of embodiment 12, wherein the step of removing the solvent comprises: (i) chemically or ionically modifying the caustic solvent (chemically or ionically modifying the solution) such that the alpha-glucan or derivative thereof, and the additive if it was dissolved in the solvent, is/are no longer dissolved in the caustic solvent, or (ii) air-blowing the solution such that the alpha-glucan or derivative thereof, and the additive if it was dissolved in the solvent, is/are no longer dissolved in the caustic solvent.
14. The method of embodiment 12 or 13, wherein the solid composition of step (c) is a fiber (e.g., filament), extrusion, fibrid, composite, powder, or film/coating.
15. The method of embodiment 12 or 13, wherein step (b) comprises using a device with one or more orifices (e.g., holes, nozzles, or perforations) through which the solution is transited/emitted/ejected/pushed through (e.g., spinneret), optionally wherein a fiber (e.g., filament) is produced in step (c).
16. A composition comprising a solid composition produced by the method of embodiment 12, 13, 14, or 15, optionally wherein the solid composition is a fiber (e.g., filament), extrusion, fibrid, composite, powder, or film/coating.
17. A composition comprising a solid composition that comprises at least water-insoluble alpha-glucan and/or a water-insoluble derivative thereof, wherein (i) the alpha-glucan and/or derivative thereof is crosslinked, and/or (ii) the composition further comprises an additive that is not chemically linked to the alpha-glucan or derivative thereof, wherein at least about 50% of the glycosidic linkages of the alpha-glucan are alpha-1,3 glycosidic linkages, and the weight-average degree of polymerization of the alpha-glucan is at least 15.
18. The composition of embodiment 17, wherein the solid composition is a fiber (e.g., filament), fibrid, extrusion, composite, powder, or film/coating.
19. The composition of embodiment 17, wherein the solid composition is a fiber (e.g., filament), and the fiber is comprised in a non-woven product or other fiber-containing product herein.

Non-limiting examples of compositions and methods disclosed herein include:
1b A composition comprising fibrids (hybrid fibrids) (or other hybrid solid composition such as a fiber [e.g., filament], extrusion, composite, powder, or film/coating herein) that comprise a water-insoluble alpha-glucan and an additive, wherein (i) at least about 50% of the glycosidic linkages of the alpha-glucan are alpha-1,3 glycosidic linkages, and the weight-average degree of polymerization of the alpha-glucan is at least 15, and (ii) the additive is not chemically linked to the alpha-glucan.
2b. The composition of embodiment 1b, wherein at least about 90% of the glycosidic linkages of the alpha-glucan are alpha-1,3 glycosidic linkages.
3b. The composition of embodiment 1b or 2b, wherein the weight-average degree of polymerization of the alpha-glucan is at least 400.
4b. The composition of embodiment 1b, 2b, or 3b, wherein the additive is aqueous-soluble under non-caustic conditions (e.g., water-soluble).
5b. The composition of embodiment 1b, 2b, or 3b, wherein the additive is aqueous-insoluble under non-caustic conditions (e.g., water-insoluble).
6b. The composition of embodiment 1b, 2b, 3b, 4b, or 5b, wherein the fibrids (or the other solid composition) comprise at least about 0.5 wt % of the additive and up to about 99.5 wt % of the water-insoluble alpha-glucan.
7b. The composition of embodiment 1b, 2b, 3b, 4b, 5b, or 6b, wherein the additive comprises a charged additive.
8b. The composition of embodiment 7b, wherein the charged additive is a cationic additive (or an anionic additive).
9b. The composition of embodiment 8b, wherein the cationic additive is a cationic polysaccharide derivative (e.g., ether) (or a cationic non-derivatized polysaccharide).
10b. The composition of embodiment 9b, wherein the polysaccharide of the cationic polysaccharide derivative is alpha-glucan, wherein at least about 50% of the glycosidic linkages of the alpha-glucan are alpha-1,3 glycosidic linkages, and the weight-average degree of polymerization of the alpha-glucan is at least 15.
11b. The composition of embodiment 9b or 10b, wherein the cationic polysaccharide derivative (or the cationic non-derivatized polysaccharide) is aqueous-soluble (or aqueous-insoluble) under non-caustic conditions.
12b. The composition of embodiment 9b, 10b, or 11b, wherein the cationic polysaccharide derivative comprises an ether-linked cationic organic group.
13b. The composition of embodiment 12b, wherein the ether-linked cationic organic group is a substituted ammonium group.
14b. The composition of embodiment 1b, 2b, 3b, 4b, 5b, 6b, 7b, 8b, 9b, 10b, 11b, 12b, or 13b, wherein the fibrids (or the other solid composition) are comprised in an aqueous medium (e.g., water or other non-caustic aqueous medium).
15b. The composition of embodiment 14b, wherein the additive is aqueous-soluble under non-caustic conditions (e.g., water-soluble).
16b. The composition of embodiment 14b or 15b, wherein at least about 80 wt % of the additive is comprised in the fibrids (or the other solid composition) (i.e., less than 20 wt % of the additive is dissolved in the aqueous medium).
17b. A method of handling fibrids (hybrid fibrids) (or other solid composition such as a fiber [e.g., filament], extrusion, composite, powder, or film/coating herein), the method comprising: (a) providing fibrids (or other solid composition such as a fiber [e.g., filament], extrusion, composite, powder, or film/coating herein) according to embodiment 1b, 2b, 3b, 4b, 5b, 6b, 7b, 8b, 9b, 10b, 11b, 12b, or 13b, and (b) contacting the fibrids (or the other solid composition) with a non-caustic aqueous liquid (or subjecting/treating under non-caustic aqueous conditions), wherein the contacting does not remove any of the additive from the fibrids (or the other solid composition), or the contacting removes less than 20 wt % of the additive from the fibrids (or the other solid composition).
18b. The method of embodiment 17b, further comprising separating the non-caustic aqueous liquid from the fibrids (or the other solid composition), wherein the non-caustic aqueous liquid does not comprise any of the additive (e.g., additive not dissolved in the liquid), or the non-caustic aqueous liquid comprises less than 20 wt % of the additive that was in the fibrids (or the other solid composition) prior to the contacting step (b).
19b. The method of embodiment 17b or 18b, wherein the additive is aqueous-soluble under non-caustic conditions (e.g., water-soluble).
20b. The method of embodiment 17b, 18b, or 19b, wherein the additive comprises a charged additive.

Non-limiting examples of compositions and methods disclosed herein include:
1c. A film/coating composition (or other hybrid solid composition such as a fiber [e.g., filament], fibrid, extrusion, composite, or powder herein) that comprises a water-insoluble alpha-glucan and a hydrophobic additive, wherein (i) at least about 50% of the glycosidic linkages of the alpha-glucan are alpha-1,3 glycosidic linkages, and the weight-average degree of polymerization of the alpha-glucan is at least 15, and (ii) the hydrophobic additive is not chemically linked to the alpha-glucan.
2c. The film/coating composition (or other hybrid solid composition) of embodiment 1c, wherein at least about 90% of the glycosidic linkages of the alpha-glucan are alpha-1,3 glycosidic linkages.
3c. The film/coating composition (or other hybrid solid composition) of embodiment 1c or 2c, wherein the weight-average degree of polymerization of the alpha-glucan is at least 400.
4c. The film/coating composition (or other hybrid solid composition) of embodiment 1c, 2c, or 3c, wherein the hydrophobic additive is aqueous-insoluble under caustic conditions and non-caustic conditions (e.g., water-insoluble).
5c. The film/coating composition (or other hybrid solid composition) of embodiment 1c, 2c, 3c, or 4c, wherein the hydrophobic additive can form an emulsion in caustic aqueous conditions and non-caustic aqueous conditions.
6c. The film/coating composition (or other hybrid solid composition) of embodiment 1c, 2c, 3c, 4c, or 5c, wherein the hydrophobic additive comprises an oil (e.g., rapeseed oil, canola oil) (or other hydrophobic additive that is a liquid that can disperse in caustic aqueous conditions).
7c. The film/coating composition (or other hybrid solid composition) of embodiment 1c, 2c, 3c, 4c, or 5c, wherein the hydrophobic additive comprises a wax.
8c. The film/coating composition (or other hybrid solid composition) of embodiment 1c, 2c, 3c, 4c, 5c, 6c, or 7c, comprising about 0.05 wt % to about 50 wt % of the hydrophobic additive, wherein this wt % is based on the weight of the alpha-glucan in the film/coating composition.
9c. The film/coating composition (or other hybrid solid composition) of embodiment 1c, 2c, 3c, 4c, 5c, 6c, 7c, or 8c, wherein one side of the film/coating is hydrophilic, and the other side of the film/coating is hydrophobic (i.e., the film/coating exhibits surface polarity in terms of water attraction/dis-attraction).
10c. The film/coating composition (or other hybrid solid composition) of embodiment 1c, 2c, 3c, 4c, 5c, 6c, 7c, 8c, or 9c, wherein the film/coating composition is a coating on a substrate, and the side of the coating (exterior coating side) that is opposite the side of the coating contacting (adjacent to) the substrate is hydrophobic (and the side contacting the substrate is hydrophilic).
11c. The film/coating composition (or other hybrid solid composition) of embodiment 1c, 2c, 3c, 4c, 5c, 6c, 7c, 8c, 9c, or 10c, wherein the film/coating composition has: (i) a tensile strength (ultimate tensile strength) of at least about 35 MPa, and/or (ii) a percent elongation (percent elongation to break) of at least about 40%.
12c. A method of producing a film/coating composition (or other hybrid solid composition) according to embodiment 1c, 2c, 3c, 4c, 5c, 6c, 7c, 8c, 9c, 10c, or 11c, the method comprising: (a) providing a preparation comprising at least (i) a caustic solvent, (ii) said water-insoluble alpha-glucan, and (iii) said hydrophobic additive, wherein the alpha-glucan is dissolved in the caustic solvent; (b) contacting the preparation with a substrate (to put the preparation into the form/shape of a film or coating) (or putting the preparation into a desired form/shape such as a fiber [e.g., filament], fibrid, or extrusion); and (c) removing the caustic solvent from the preparation of step (b) to produce a film/coating composition (or other hybrid solid composition such as a fiber [e.g., filament], fibrid, or extrusion) comprising the alpha-glucan and the additive.
13c. The method of embodiment 12c, wherein the preparation is a dispersion, and wherein the hydrophobic additive is dispersed in the caustic solvent.
14c. The method of embodiment 12c or 13c, wherein the dispersion is an emulsion (or the preparation is an emulsion), wherein the hydrophobic additive is dispersed as an emulsion in the caustic solvent (i.e., the hydrophobic additive is a liquid that is not miscible with the caustic solvent).
15c. The method of embodiment 12c, 13c, or 14c, wherein the step of removing the caustic solvent comprises: (i) chemically or ionically modifying the caustic solvent (chemically or ionically modifying the preparation) such that the alpha-glucan is no longer dissolved in the caustic solvent, or (ii) air-blowing the preparation such that the alpha-glucan is no longer dissolved in the caustic solvent.
16c. The method of embodiment 12c, 13c, 14c, or 15c, wherein the substrate comprises glass.
17c. The method of embodiment 12c, 13c, 14c, or 15c, wherein the substrate is a cellulose substrate (e.g., paper, cardboard, paperboard, corrugated board, or boxboard).
18c. The method of embodiment 12c, 13c, 14c, 15c, 16c, or 17c, further comprising a step of heating the film/coating composition (or other hybrid solid composition such as a fiber [e.g., filament], extrusion, fibrid, powder, or composite) to a temperature of at least about 45° C. (or to a temperature that melts the hydrophobic additive, optionally if the hydrophobic additive is a solid at 20-25° C.).
19c. The method of embodiment 12c, 13c, 14c, 15c, 16c, 17c, or 18c, wherein the hydrophobic additive has a melting temperature of at least about 45° C.
20c. A film/coating (or other hybrid solid composition such as a fiber [e.g., filament], extrusion, fibrid, or composite) produced by the method of embodiment 12c, 13c, 14c, 15c, 16c, 17c, 18c, or 19c.

### EXAMPLES

The present disclosure is further exemplified in the following Examples. It should be understood that these Examples, while indicating certain aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

### Materials/Methods

### Representative Method of Preparing Solution (Dope) of Insoluble Alpha-Glucan

Unless otherwise disclosed, alpha-glucan dope solutions were made comprising about 7.5-15 wt % alpha-1,3-glucan (DPw ˜800, ˜100% alpha-1,3 linkages, aqueous-insoluble under non-caustic conditions) and about 4.2-4.5 wt % NaOH in water. Generally, a dope solution was made by charging a reactor with water and then adding alpha-1,3-glucan dry powder under agitation. After the glucan powder became visibly uniformly dispersed, an NaOH solution was added, after which the reactor contents were further agitated for about 30 minutes. Final alpha-1,3-glucan dope solutions were clear without any color. One or more additives could be added before, during, or after addition of the NaOH.

### Example 1

### Crosslinking Alpha-Glucan in a Dope Solution

In this Example, various levels of ethylene glycol diglycidyl ether (EGDGE) crosslinker were added to alpha-1,3-glucan dope solutions and their rheological properties were monitored.

A dope solution with 10 wt % water-insoluble alpha-1,3-glucan, 4.5 wt % NaOH, and 85.5 wt % water was prepared and divided into aliquots. Immediately after this dope solution was prepared, 0 wt %, 0.1 wt %, or 1 wt % EGDGE (relative to the weight of alpha-1,3-glucan in the dope) (PolySource, Independence, MO) was added to an aliquot of the dope solution and stirred for 30 minutes using an overhead mixer with a propeller impeller (50 rpm). The rheological properties of each aliquot was then measured using an oscillatory shear rheometer (Malvern, Kinexus) with a cone-plate geometry. An oscillatory frequency of 1 Hz was used and the elastic modulus (G′) and viscous modulus (G″) were measured by varying the strain from 0.1% to 100%. These measurements were taken immediately (day 0) or after one day. Table 1 below provides the G′ and G″ values measured at a strain of 1%.

TABLE 1

| | EGDGE Content Relative to Weight of | | | | | |
|---|---|---|---|---|---|---|
| | Alpha-1,3-Glucan in Dope | | | | | |
| | 0 wt % | | 0.1 wt % | | 1 wt % | |
| Time | G′ (Pa) | G″ (Pa) | G′ (Pa) | G″ (Pa) | G′ (Pa) | G″ (Pa) |
| Day 0 | 3.229 | 32.76 | 2.054 | 29.12 | 4.394 | 35.4 |
| Day 1 | 1.599 | 30.93 | 2.525 | 39.3 | 94.85 | 163.2 |

It was observed (Table 1) that, with no addition (0 wt %) of EGDGE to alpha-1,3-glucan dope solution, the respective differences in G′ and G″ from day 0 to day 1 were negligible. However, with 0.1 wt % and 1 wt % addition of EGDGE, there were noticeable increases in the respective G′ and G″ values from day 0 to day 1, suggesting that it took some time between 0-1 days for EGDGE crosslinking to fully occur. For 1 wt % addition of EGDGE, respective increases in G′ and G″ were observed, even at day 0, as compared to the 0 wt % and 0.1 wt % EGDGE samples, suggesting that crosslinking can occur rapidly at a relatively higher EGDGE concentration.

### Example 2

Producing Continuous Dope Filaments with Crosslinked Alpha-Glucan Dope Solution

A dope solution was prepared having 7.5 wt % water-insoluble alpha-1,3-glucan and 4.5 wt % NaOH, and 1 wt % EGDGE (relative to the weight of alpha-1,3-glucan in the dope). After one day, this dope solution, as well as a corresponding dope solution having no EGDGE crosslinker, were individually used in a fiber air-blowing apparatus equipped with a meltblown die (Exxon type Meltblown Die, fifty-eight 500-micron holes).

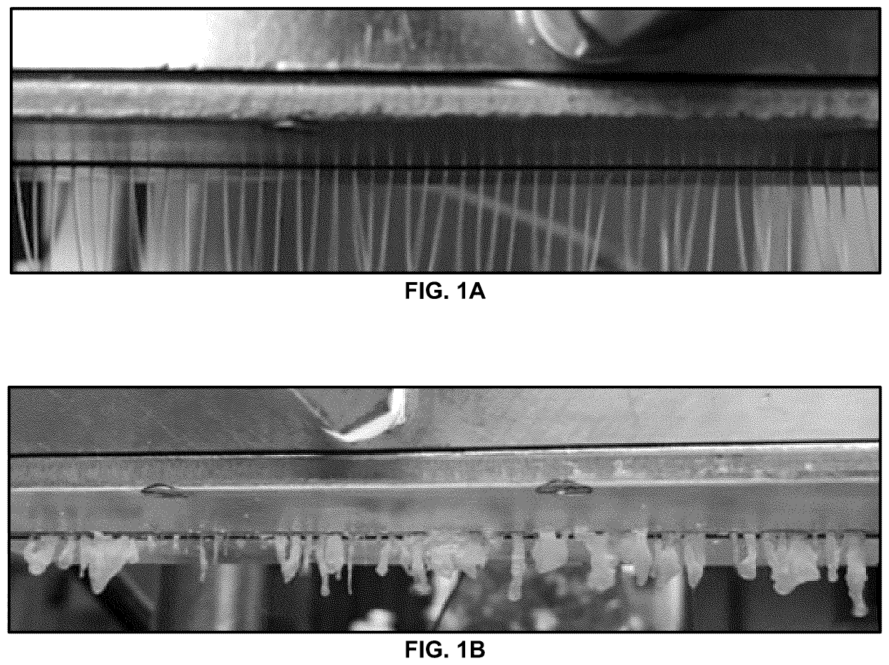

Air-drawing of the crosslinked (EGDGE-treated) alpha-1,3-glucan dope solution was possible with air flow pressures up to about 100 mbar without breakage of the dope filaments (continuous dope filaments were produced); see FIG. 1A. In contrast, this process was not possible when trying to air-draw the alpha-1,3-dope solution that did not contain crosslinker, as each attempt therewith led to deformation and/or breaking of the air-drawn dope (uniform dope filaments could not be produced); see FIG. 1B. These results were not foreseen, as including a crosslinker might have been expected to render rheological conditions not amenable to drawing continuous dope filaments.

### Example 3

### Fiber Produced Using Crosslinked Alpha-Glucan Dope Solution

Fibers were produced using dope solutions having 7.5 wt % water-insoluble alpha-1,3-glucan and 4.5 wt % NaOH, and 0.1, 0.5, or 1.0 wt % EGDGE (relative to the weight of alpha-1,3-glucan in the dope). Each dope solution was made and held for one day before being entered into fiber production. For fiber production, a fiber spinning nozzle with one-hundred-twenty 60-micron diameter holes was used. An extrusion speed of 13.3 m/min and spinning speed of 25 m/min were used. An increase in nozzle pressure proportional to the EGDGE content of each dope solution was observed when producing dope filaments (see Table 2 below). For coagulation of dope filaments into fibers, a solution containing 80 g/L H₂SO₄, 220 g/L Na₂SO₄, and 30 g/L ZnSO₄ at 42° C. was used. Following coagulation, fibers were washed with water and dried at 70° C.

Each of the fibers was tested for tenacity, elastic modulus (E-modulus) and elongation. A yarn (bundle of 120 fibers) of each prepared fiber was used for these tests. Table 2 below shows the results of these analyses.

TABLE 2

| EGDGE Content Relative | | | | |
|---|---|---|---|---|
| to Weight of Alpha-1,3- | Nozzle | Fiber | Fiber E- | Fiber |
| Glucan in Dope | Pressure | Tenacity | Modulus | Elongation |
| 0.1 wt % | 1.4 bar | 9.95 cN/tex | 391 cN/tex | 11.1% |
| 0.5 wt % | 1.9 bar | 11.6 cN/tex | 411 cN/tex | 12.4% |
| 1.0 wt % | 3.9 bar | 13.8 cN/tex | 447 cN/tex | 13.0% |

### Example 4

### Film Produced Using Crosslinked Alpha-Glucan Dope Solution

Alpha-1,3-glucan films were produced using dope solutions containing either 1,4-butanediol diglycidyl ether (BDGE) or polyethylene glycol 2000 diglycidyl ether (PEG2000DGE) as a crosslinker.

Alpha-1,3-glucan dope solutions were prepared comprising 15 wt % water-insoluble alpha-1,3-glucan, 4.9 wt % NaOH and 80.1 wt % water, after which 0 wt %, 0.01 wt %, or 0.05 wt % BDGE, or 0.01 wt % PEG2000DGE, was added (relative to the weight of alpha-1,3-glucan in the dope). Films were then cast onto a glass surface using a 100-micron doctor blade. The cast films were coagulated using a 5% H₂SO₄/2.5% Na₂SO₄ aqueous bath and washed with DI water until neutral. The films were then treated in a 5% glycerol aqueous bath and dried.

Each film as produced above was tested for tensile strength and elongation. Alpha-1,3-glucan films produced using a dope solution containing crosslinker exhibited higher tensile strength and elongation properties as shown in Table 3 below. These features were increased as compared to film produced using alpha-1,3-glucan dope solution lacking crosslinker (Table 3).

TABLE 3

| Crosslinker (Content Relative | | |
|---|---|---|
| to Weight of Alpha-1,3-Glucan | Film Tensile | Film |
| in Dope) | Strength | Elongation |
| no crosslinker | 26.2 MPa | 36.4% |
| BDGE (0.01 wt %) | 37.8 MPa | 61.8% |
| BDGE (0.05 wt %) | 41.6 MPa | 53.5% |
| PEG2000DGE (0.01 wt %) | 35.8 MPa | 63.6% |

### Example 5

### Film Produced Using Alpha-Glucan Dope Solution Including Additive

Alpha-1,3-glucan films were produced using dope solutions containing at least one additive.

Alpha-1,3-glucan dope solutions were prepared comprising 15 wt % water-insoluble alpha-1,3-glucan, 4.9 wt % NaOH and 80.1 wt % water, after which 10 wt % carbon black or bentonite clay was added (relative to the weight of alpha-1,3-glucan in the dope). Films were then cast onto a glass surface using a 100-micron doctor blade. The cast films were coagulated using a 5% H₂SO₄/2.5% Na₂SO₄ aqueous bath and washed with DI water until neutral. The films were then treated in a 5% glycerol aqueous bath and dried.

The film containing carbon black was black in color and entirely opaque, while the film containing bentonite was cloudy white/translucent. Alpha-1,3-glucan film produced using a dope solution without any additive was clear/transparent.

### Example 6

### Hybrid Fibrids Produced Using Alpha-Glucan Dope Solution Including Additive

Alpha-1,3-glucan fibrids were produced using dope solutions containing at least one additive. In particular, fibrids were produced having water-insoluble alpha-1,3-glucan with water-soluble cationic ether alpha-1,3-glucan derivative as an additive.

Dope solutions were prepared comprising non-derivatized water-insoluble alpha-1,3-glucan (DPw ˜800, ˜100% alpha-1,3 linkages) and a cationic ether derivative thereof (hydroxypropyl trimethyl amine ether derivative, DoS 0.3, aqueous-soluble under non-caustic conditions; i.e., insoluble in water). Each dope solution contained a total glucan content (alpha-1,3-glucan and its ether derivative) of 13 wt % and 4.5 wt % NaOH in water. The ratio of alpha-1,3-glucan to its ether derivative in the prepared dope samples was 100:0 (i.e., no derivative), 95:5, or 80:20 (w/w ratio). The dopes were prepared at room temperature (20-25° C.); after blending the glucan, water and NaOH, each dope solution was mixed and held for 1 hour.

For fibrid production, each dope solution was fed simultaneously with 1.5% H₂SO₄ into a shear mixer and mixed (room temperature, tip speed 38 m/s, mixing time <1 second). The shear mixer homogenized the dope and acid solutions resulting in a decrease in overall pH, thereby precipitating the alpha-1,3-glucan (now in the form of fibrids). Aside from glucan fibrids, Na₂SO₄ salt (from the acid-base reaction) and residual acid were present after the mixing. The final mixture had a pH of about 2-3.

The fibrids were washed in water and analyzed for degree of substitution (DOS) by NMR and aspect ratio (Table 4)

TABLE 4

| Alpha-1,3-glucan to | |
|---|---|
| derivative ratio^{a} as | Fibrids Features |

| used in dope solution | Aspect Ratio | | Zeta Potential |
|---|---|---|---|
| used to prepare fibrids | (H/Ho) | DOS | (mV) |
| 100:0 | 50 | 0.0 | −0.01 |
| 95:5 | 40 | 0.01^{c} | +8.6 |
| 80:20 | 30 | 0.06^{c} | +29.85 |
| 0:100^{b} | na | 0.03 | +18.59 |

^{a}Weight-to-weight ratio.
^{b}Hydroxypropyl trimethyl amine ether of alpha-1,3-glucan (DPw ~800, ~100% alpha-1,3 linkages) with DoS of 0.03. Insoluble under non-caustic aqueous conditions such as regular water. na (not available).
^{c}This DoS measurement is an “effective DoS” in that the analyzed fibrid samples contained both etherified glucan (DoS 0.3) and non-derivatized glucan (DoS 0.0).

The high aspect ratios of the samples that were measured (Table 4) confirm that the products were in the form of fibrids. NMR confirmed that the fibrids produced using dope solutions having both alpha-1,3-glucan and the cationic derivative thereof have a DoS measurement, and these fibrids were confirmed to have positive charge by zeta potential analysis in de-ionized water (Table 4). Thus, the fibrids were able to trap charge on and/or within the fibrid structure. This is a noteworthy finding. Since the cationic alpha-1,3-glucan derivative used here is water-soluble, it potentially could have stayed in solution and gotten washed away during the fibrid production process. However, even after washing, it was found that charge was retained on/within the fibrid particles. It is contemplated that other water-soluble materials can likewise be retained in solid alpha-1,3-glucan products herein.

The process described in this Example facilitates adjustment of charge when producing fibrids, and presumably other solid products. By changing the amount of a charged glucan derivative additive in a dope solution having non-derivatized glucan, one can modulate the charge on fibrids and presumably other solids made using the dope solution. Now, instead of requiring a particularly charged glucan derivative to be on hand to make a particularly charged solid material, one can simply blend a charged glucan derivative additive from a stock supply thereof to non-derivatized glucan to achieve the desired charge in the solid product. This blending approach also allows for making solid products with unique/tunable charge distributions (depending on how mixing is conducted), as compared to using a charged glucan derivative as the only glucan component in the product, which results in a fixed charge distribution across all products made using the charged glucan derivative.

### Example 7

### Films Produced Using Alpha-Glucan Dope Solution Including Additive

Alpha-1,3-glucan films were produced using dope solutions containing at least one additive.

This Example discloses the use of additives to improve the mechanical properties (e.g., ultimate tensile strength, elongation) of alpha-1,3-glucan-based materials such as self-standing films. Small addition of an additive—in some cases, less than 0.1 wt % of the additive relative to the alpha-1,3-glucan content-improved ultimate tensile strength to about 140% and elongation to 77% in self-standing films comprising alpha-1,3-glucan. In addition, by using oil as an additive, it was shown that alpha-1,3-glucan films can be produced having dual hydrophilic and hydrophobic behavior.

The following chemicals/compounds were used in this Example: alpha-1,3-glucan (IFF, ˜100% alpha-1,3 linkages, DPw ˜800), NaOH (99.5%, ChemSolute), sulfuric acid (95%, ChemSolute), sodium lauryl sulfate (Carlo Erda), BDGE (1,4-butanediol diglycidyl ether, >95%, Sigma Aldrich), polyvinyl alcohol (Kuraray Exceval™ AQ-4140, ethylene-modified PVA, degree of hydrolysis 98-99 mol %), paraffin wax (Fluka Chemika, ref. no. 76233), rapeseed oil (Bellasan®), glycerol (99.5%, Th. Geyer), sodium sulfate (99%, ChemSolute).

The caustic dopes used in this work were prepared by dissolving alpha-1,3-glucan in an aqueous solution of NaOH (4.2 wt %) at room temperature; the final concentration of the alpha-1,3-glucan in the dope was 15 wt %. Additive was added to this formulation. The amount of additive listed in this Example is relative to the amount of alpha-1,3-glucan in the formulation (and thus also to the amount of alpha-1,3-glucan in dry film produced with the caustic dope).

Caustic dopes containing alpha-1,3-glucan and additive were used to make films as follows. All work was performed at room temperature, except as otherwise noted. Dope was poured onto a glass plate, and a blade coater (ELCOMETER model 3530/4) with a gap of about 420 μm was used to cast a film. The glass and the casted film were introduced into a coagulation bath filled with an aqueous solution of sulfuric acid (5 wt %) and sodium sulphate (2.5 wt %) for 5 minutes. The film was detached from the glass plate half-way during coagulation. The film was then submerged in a water bath for 40 minutes. Then, the film was introduced in a bath filled with water and glycerol (5 wt %) for 60 minutes. Once this process was completed, the film was dried for about 20 hours at room temperature applying weight in the corners to prevent shrinkage. Finally, the film was introduced to an oven at 68° C. for 2 hours to obtain a completely dried film. Films had a thickness of about 50 μm.

The ultimate tensile strength (in megapascals [MPa]) and elongation (percent elongation to break) of films were measured using DIN EN ISO 527-3 (incorporated herein by reference) standard procedures. The samples were tested in an AllroundLine Z005 material testing machine with a preload of 0.1 MPa, a test speed of 200 mm/min, and a length at start position of 30.00 mm.

### Example 7A

The crosslinker, BDGE, was used as an additive in producing alpha-1,3-glucan films to determine if it could improve the mechanical properties of alpha-1,3-glucan film products. Various amount of BDGE were added to alpha-1,3-glucan dope solution at room temperature while stirring, and films were prepared therewith (per above methodology). Ultimate tensile strength and percent elongation of each film were measured (Table 5).

TABLE 5

| | BDGE relative to glucan (wt %) | | | | |
|---|---|---|---|---|---|
| | 0 | 0.005 | 0.01 | 0.05 | 0.1 |
| Ultimate tensile | 25 | 32 | 38 | 42 | 33 |
| strength (MPa) | | | | | |
| Elongation (%) | 35 | 45 | 62 | 54 | 50 |

Increases of up to ˜68% in ultimate tensile strength and ˜77% in percent elongation were observed in alpha-1,3-glucan films having BDGE additive.

### Example 7B

PVA was dissolved in water (1 wt %) and certain amounts of this solution were added to a mixture of alpha-1,3-glucan (15 wt %) in water. NaOH was then added to dissolve the alpha-1,3-glucan while stirring for 2 hours. Films were prepared from these dope solutions (per above methodology). Ultimate tensile strength and percent elongation of each film were measured (Table 6).

TABLE 6

| | PVA relative to glucan (wt %) | | | | |
|---|---|---|---|---|---|
| | 0 | 0.1 | 0.3 | 0.5 | 1.0 |
| Ultimate tensile | 26 | 51 | 57 | 63 | 50 |
| strength (MPa) | | | | | |
| Elongation (%) | 36 | 26 | 36 | 43 | 41 |

Increases of up to ˜142% in ultimate tensile strength and ˜17% in percent elongation were observed in alpha-1,3-glucan films having PVA additive.

### Example 7C

Paraffin wax was added to a mixture of alpha-1,3-glucan (15 wt %) in water with about 0.005 wt % sodium lauryl sulfate. NaOH was then added to dissolve the alpha-1,3-glucan while stirring for 2 hours; the paraffin wax was dispersed in the dope that was produced. Films were prepared from these dope emulsions (per above methodology). Ultimate tensile strength and percent elongation of each film were measured (Table 7).

TABLE 7

Paraffin wax relative to glucan (wt %)^{a}

| | 0 | 0.1 | 0.5 | 5 | 10 |
|---|---|---|---|---|---|
| Ultimate tensile | 26 | 41 | 41 | 52 | 58 |
| strength (MPa) | | | | | |
| Elongation (%) | 36 | 43 | 32 | 49 | 48 |

^{a}Films with 15 wt % and 20 wt % (relative to glucan) paraffin wax were also prepared.

Increases of up to ˜123% in ultimate tensile strength and ˜36% in percent elongation were observed in alpha-1,3-glucan films having paraffin wax additive.

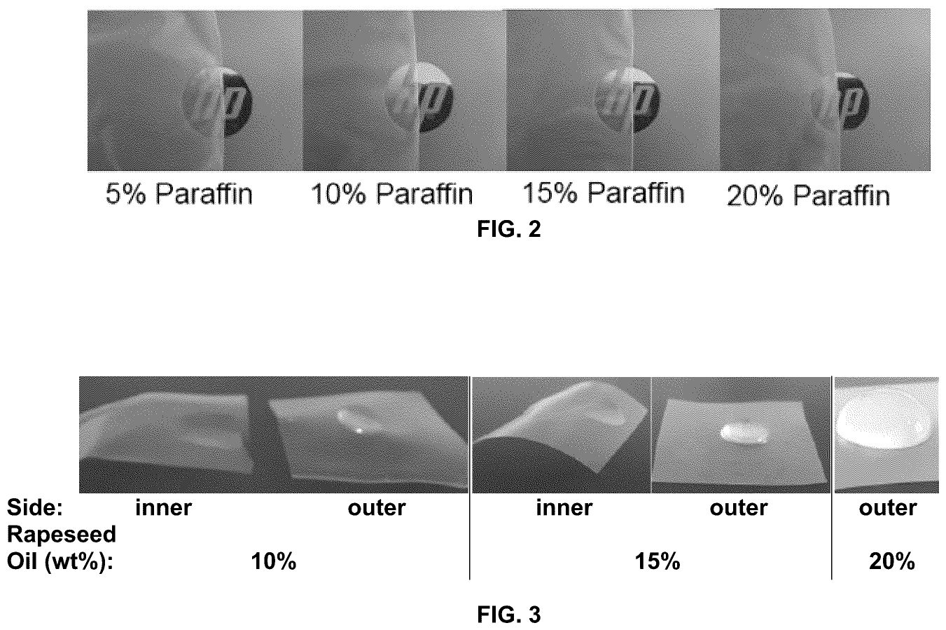

In addition, light transparency activity was retained in alpha-1,3-glucan films having paraffin wax additive (FIG. 2).

### Example 7D

Rapeseed oil was added to a mixture of alpha-1,3-glucan (15 wt %) in water with about 0.005 wt % sodium lauryl sulfate. The amount of rapeseed oil used was for having 10, 15, or 20 wt % rapeseed oil, where the wt % is relative to the alpha-1,3-glucan content. NaOH was then added to dissolve the alpha-1,3-glucan while stirring for 2 hours; the rapeseed oil was dispersed in the dope that was produced. Films were prepared from these dope emulsions (per above methodology).

Notably, films containing alpha-1,3-glucan and rapeseed oil exhibited a polarity in which one side was hydrophilic and the other side was hydrophobic. In particular, the side of the film that formed in direct contact with the glass (“inner side”) was hydrophilic, while the opposite side (“outer side”) was hydrophobic. This hydrophilic/hydrophobic nature was discerned, for example, by observing that water placed on the inner (hydrophilic) side of the film had a low contact angle with the film, whereas water placed on the outer (hydrophobic) side of the film readily beaded into droplets having a high contact angle with the film (FIG. 3). This polarity in water-film association was not observed with alpha-1,3-glucan film lacking rapeseed oil; water generally beaded up in the same manner on both the inner and outer sides of the film (data not shown). This hydrophilic/hydrophobic nature of film surfaces was not observed with alpha-1,3-glucan film having paraffin wax of Example 7C (data not shown).

What is claimed is:

1. A solution comprising at least (a) a caustic solvent, (b) alpha-glucan or a derivative thereof, and (c) an additive,
wherein the additive is (i) a crosslinking agent, and/or (ii) an additive that does not chemically react with said alpha-glucan or derivative thereof,
wherein at least about 50% of the glycosidic linkages of the alpha-glucan are alpha-1,3 glycosidic linkages, and the weight-average degree of polymerization of the alpha-glucan is at least 15,
wherein the alpha-glucan or derivative thereof is dissolved in the caustic solvent, and the additive is dissolved or not dissolved in the caustic solvent.

2. The solution of claim 1, wherein at least about 90% of the glycosidic linkages of the alpha-glucan are alpha-1,3 glycosidic linkages.

3. The solution of claim 1, wherein the solution comprises the alpha-glucan.

4. The solution of claim 1, wherein the solution comprises about 5 wt % to about 20 wt % of the alpha-glucan or derivative thereof.

5. The solution of claim 1, wherein the additive is the crosslinking agent.

6. The solution of claim 1, wherein the additive is the additive that does not react with said alpha-glucan or derivative thereof.

7. The solution of claim 6, wherein the additive is aqueous-soluble under non-caustic conditions.

8. The solution of claim 1, wherein the additive is a polysaccharide derivative.

9. The solution of claim 1, wherein the caustic solvent is aqueous alkali metal hydroxide.

10. The solution of claim 1, wherein the solution is in the form of a dope filament.

11. A method of producing a solution according to claim 1, said method comprising:
mixing at least the alpha-glucan or derivative thereof, and the additive, with a caustic solvent, wherein the alpha-glucan or derivative thereof dissolves in the caustic solvent.

12. A method of producing a solid composition, said method comprising:
(a) providing a solution according to claim 1,
(b) putting the solution into a desired form, and
(c) removing the caustic solvent from the solution of step (b) to produce a solid composition comprising the alpha-glucan or derivative thereof, and the additive.

13. The method of claim 12, wherein said removing the solvent comprises:
(i) chemically or ionically modifying the caustic solvent such that the alpha-glucan or derivative thereof, and the additive if it was dissolved in the solvent, is/are no longer dissolved in the caustic solvent, or
(ii) air-blowing the solution.

14. The method of claim 12, wherein the solid composition of step (c) is a fiber/filament, fibrid, extrusion, composite, or film/coating.

15. The method of claim 12, wherein step (b) comprises using a device with one or more orifices through which the solution is transited/emitted/ejected/pushed through, optionally wherein a fiber/filament is produced in step (c).

16. A composition comprising a solid composition produced by the method of claim 12, optionally wherein the solid composition is a fiber/filament, extrusion, fibrid, composite, or film/coating.

17. A composition comprising a solid composition that comprises at least water-insoluble alpha-glucan or a water-insoluble derivative thereof, wherein
(i) the alpha-glucan or derivative thereof is crosslinked, and/or
(ii) the composition further comprises an additive that is not chemically linked to the alpha-glucan or derivative thereof,
wherein at least about 50% of the glycosidic linkages of the alpha-glucan are alpha-1,3 glycosidic linkages, and the weight-average degree of polymerization of the alpha-glucan is at least 15.

18. The composition of claim 17, wherein the solid composition is a fiber/filament, fibrid, extrusion, composite, powder, or film/coating.

19. The composition of claim 17, wherein the solid composition is a fiber/filament, and the fiber/filament is comprised in a non-woven product.
